(19) United States
(12) Patent Application Publication
(10) Pub. No.: US 2024/0365354 A1
(43) Pub. Date: Oct. 31, 2024

(54) SCHEDULING REQUEST-INDICATED REPORTING ENHANCEMENTS

(71) Applicant: QUALCOMM Incorporated, San Diego, CA (US)

(72) Inventors: Ahmed ELSHAFIE, San Diego, CA (US); Huilin XU, Temecula, CA (US); Diana MAAMARI, San Diego, CA (US)

(21) Appl. No.: 18/308,513

(22) Filed: Apr. 27, 2023

(51) Int. Cl. H04W 72/51; H04W 28/02; H04W 72/21

(52) U.S. Cl. CPC H04W 72/51; H04W 28/0278; H04W 72/21

(57) ABSTRACT

Methods, systems, and devices for wireless communications are described. In some examples, a user equipment (UE) may transmit a scheduling request to indicate performance of a UE operation at the UE. For example, the UE may receive first control information indicative of a correspondence between one or more operations at the UE and at least one or more candidate values of a scheduling request. In such examples, one of the one or more candidate values may be zero. The UE may transmit the scheduling request in accordance with the first control information, where the value of the scheduling request may be indicative, at least in part, of a UE operation of the one or more operations. In response to transmitting the scheduling request, the UE may perform the UE operation in accordance with the value of the scheduling request.

### INTRODUCTION

The following relates to wireless communications, and more specifically to managing reporting from a user equipment (UE).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as UE.

### SUMMARY

A method for wireless communication at a user equipment (UE) is described. The method may include receiving first control information indicative of a correspondence between one or more operations at the UE and at least one or more candidate values of a scheduling request, transmitting the scheduling request in accordance with the first control information, a value of the scheduling request indicative, at least in part, of a UE operation of the one or more operations, and performing the UE operation in accordance with the value of the scheduling request.

An apparatus for wireless communication at a UE is described. The apparatus may include a processor, memory coupled with the processor, and instructions stored in the memory. The instructions may be executable by the processor to cause the apparatus to receive first control information indicative of a correspondence between one or more operations at the UE and at least one or more candidate values of a scheduling request, transmit the scheduling request in accordance with the first control information, a value of the scheduling request indicative, at least in part, of a UE operation of the one or more operations, and perform the UE operation in accordance with the value of the scheduling request.

Another apparatus for wireless communication at a UE is described. The apparatus may include means for receiving first control information indicative of a correspondence between one or more operations at the UE and at least one or more candidate values of a scheduling request, means for transmitting the scheduling request in accordance with the first control information, a value of the scheduling request indicative, at least in part, of a UE operation of the one or more operations, and means for performing the UE operation in accordance with the value of the scheduling request.

A non-transitory computer-readable medium storing code for wireless communication at a UE is described. The code may include instructions executable by a processor to receive first control information indicative of a correspondence between one or more operations at the UE and at least one or more candidate values of a scheduling request, transmit the scheduling request in accordance with the first control information, a value of the scheduling request indicative, at least in part, of a UE operation of the one or more operations, and perform the UE operation in accordance with the value of the scheduling request.

Some examples of the method, apparatuses, and non-transitory computer-readable medium described herein may further include operations, features, means, or instructions for transmitting one of a buffer status report (BSR), a delay status report (DSR), an energy status report (ESR), or combinations thereof in accordance with the value of the scheduling request and the correspondence.

Some examples of the method, apparatuses, and non-transitory computer-readable medium described herein may further include operations, features, means, or instructions for receiving, as part of the first control information, an indication of different reports or different report formats as the one or more operations at the UE, the one or more candidate values of the scheduling request each associated with a respective report or report format in accordance with the correspondence.

In some examples of the method, apparatuses, and non-transitory computer-readable medium described herein, the different report formats to include one or more of a first BSR which includes a first table, a second BSR which includes a second table different from the first table, or a third BSR which includes a two-part table.

Some examples of the method, apparatuses, and non-transitory computer-readable medium described herein may further include operations, features, means, or instructions for receiving, as part of the first control information, an indication of different start indices of a report of the UE as the one or more operations at the UE, the one or more candidate values of the scheduling request each associated with a respective start index in accordance with the correspondence.

Some examples of the method, apparatuses, and non-transitory computer-readable medium described herein may further include operations, features, means, or instructions for transmitting a medium access control-control element (MAC-CE) indicative of an ESR in accordance with the value of the scheduling request and the correspondence, the media access control MAC-CE also indicative of a BSR or report separate from the BSR.

Some examples of the method, apparatuses, and non-transitory computer-readable medium described herein may further include operations, features, means, or instructions for cancelling a physical downlink control channel (PDCCH) skip procedure in accordance with the value of the scheduling request and the correspondence.

Some examples of the method, apparatuses, and non-transitory computer-readable medium described herein may further include operations, features, means, or instructions for switching between operations in a first search space set group (SSSG) to operations in a second SSSG in accordance with the value of the scheduling request and the correspondence.

Some examples of the method, apparatuses, and non-transitory computer-readable medium described herein may further include operations, features, means, or instructions for switching between a first communications state to a second communications state in accordance with the value of the scheduling request and the correspondence.

Some examples of the method, apparatuses, and non-transitory computer-readable medium described herein may further include operations, features, means, or instructions for transmitting, via layer 1 (L1) resources or layer 2 (L2) resources, a MAC-CE that requests to operate in a first SSSG, to skip one or more PDCCH resources, or to operate in a first communications state, the request of the MAC-CE being in accordance with the value of the scheduling request and the correspondence.

Some examples of the method, apparatuses, and non-transitory computer-readable medium described herein may further include operations, features, means, or instructions for receiving control signaling indicating the L1 resources or the L2 resources for transmission of the MAC-CE.

Some examples of the method, apparatuses, and non-transitory computer-readable medium described herein may further include operations, features, means, or instructions for transmitting a BSR that includes a second value, the correspondence to be further between the UE operation and a combination of the value of the scheduling request and the second value of the BSR and performance of the UE operation to be further in accordance with the combination of the value of the scheduling request and the second value of the BSR.

Some examples of the method, apparatuses, and non-transitory computer-readable medium described herein may further include operations, features, means, or instructions for transmitting one of a DSR, an ESR, an indication of a SSSG switch, or of a PDCCH skip procedure update, in combination with the BSR in accordance with the value of the scheduling request, the second value of the BSR, and the correspondence.

In some examples of the method, apparatuses, and non-transitory computer-readable medium described herein, the DSR indicative of one of a set of multiple values associated with the DSR based on the combination of the value of the scheduling request, the second value of the BSR, and the correspondence.

In some examples of the method, apparatuses, and non-transitory computer-readable medium described herein, the DSR indicative that a remaining packet delay budget (PDB), a wait time of an uplink message of the UE, or both satisfy one or more delay thresholds based on the combination of the value of the scheduling request, the second value of the BSR, and the correspondence.

In some examples of the method, apparatuses, and non-transitory computer-readable medium described herein, the ESR indicative of one of a set of multiple values associated with the ESR based on the combination of the value of the scheduling request, the second value of the BSR, and the correspondence.

In some examples of the method, apparatuses, and non-transitory computer-readable medium described herein, the ESR indicative of one of a charging rate of the UE, a charging request of the UE, or a combination thereof based on the combination of the value of the scheduling request, the second value of the BSR, and the correspondence.

Some examples of the method, apparatuses, and non-transitory computer-readable medium described herein may further include operations, features, means, or instructions for receiving, as part of the first control information, an indication that the scheduling request may be associated with a reduced quantity of logical channel groups (LCG), the value of the scheduling request indicative that a BSR may be to include information associated with the reduced quantity of LCGs and transmitting the BSR that includes the information associated with the reduced quantity of LCGs in accordance with the value of the scheduling request and the correspondence, a header of the BSR indicative of one or more unused portions of the BSR.

In some examples of the method, apparatuses, and non-transitory computer-readable medium described herein, the one or more unused portions of the BSR to include the information associated with the reduced quantity of LCGs, the information to include an ESR associated with each of the reduced quantity of LCGs, a DSR associated with each of the reduced quantity of LCGs, the BSR associated with each of the reduced quantity of LCGs, or a combination thereof.

In some examples of the method, apparatuses, and non-transitory computer-readable medium described herein, each LCG of the reduced quantity of LCGs to be associated with a respective priority.

In some examples of the method, apparatuses, and non-transitory computer-readable medium described herein, the information associated with the reduced quantity of LCGs to be jointly encoded in the one or more unused portions of the BSR.

In some examples of the method, apparatuses, and non-transitory computer-readable medium described herein, a first unused portion of the one or more unused portions of the BSR to include a codeword indicative of at least a type of the information included in the one or more unused portions of the BSR, a format of the information included in the one or more unused portions of the BSR, a table associated with the information included in the one or more unused portions of the BSR, or a combination thereof.

In some examples of the method, apparatuses, and non-transitory computer-readable medium described herein, the value of the scheduling request to include at least two bits of information.

Some examples of the method, apparatuses, and non-transitory computer-readable medium described herein may further include operations, features, means, or instructions for receiving second control information that indicates a set of physical uplink control channel (PUCCH) resources, transmitting, via a resource of the set of PUCCH resources, uplink control information indicative of a type of a report to be transmitted via a MAC-CE, and transmitting the MAC-CE that includes the report in accordance with the uplink control information.

Some examples of the method, apparatuses, and non-transitory computer-readable medium described herein may further include operations, features, means, or instructions for receiving a request for the UE to report at least one of a set of multiple reports, transmitting an indication that the UE may be to transmit a first report of the set of multiple reports and a first format of the first report, the first format of the first report to be based on a quantity of bits associated with a set of multiple LCGs at the UE, and transmitting the first report formatted in accordance with the indication.

In some examples of the method, apparatuses, and non-transitory computer-readable medium described herein, performance of the UE operation to be in accordance with a duration of a timer.

Some examples of the method, apparatuses, and non-transitory computer-readable medium described herein may further include operations, features, means, or instructions for transmitting a message that includes a request to alter the duration of the timer and receiving a second message to alter the duration of the timer based on the request, performance the UE operation to be based on the second message to alter the duration of the timer.

In some examples of the method, apparatuses, and non-transitory computer-readable medium described herein, the UE operation to be at least a transmission of one of a BSR, a DSR, or an ESR, and the value of the scheduling request to be based on a respective priority associated with each of the BSR, the DSR, and the ESR.

In some examples of the method, apparatuses, and non-transitory computer-readable medium described herein, one of the one or more candidate values of the scheduling request included in the correspondence being zero.

A method for wireless communication at a network entity is described. The method may include outputting first control information indicative of a correspondence between one or more operations at a UE and at least one or more candidate values of a scheduling request, obtaining the scheduling request in accordance with the first control information, a value of the scheduling request indicative, at least in part, of a UE operation of the one or more operations, and performing a network operation corresponding to the UE operation that is in accordance with the value of the scheduling request.

An apparatus for wireless communication at a network entity is described. The apparatus may include a processor, memory coupled with the processor, and instructions stored in the memory. The instructions may be executable by the processor to cause the apparatus to output first control information indicative of a correspondence between one or more operations at a UE and at least one or more candidate values of a scheduling request, obtain the scheduling request in accordance with the first control information, a value of the scheduling request indicative, at least in part, of a UE operation of the one or more operations, and perform a network operation corresponding to the UE operation that is in accordance with the value of the scheduling request.

Another apparatus for wireless communication at a network entity is described. The apparatus may include means for outputting first control information indicative of a correspondence between one or more operations at a UE and at least one or more candidate values of a scheduling request, means for obtaining the scheduling request in accordance with the first control information, a value of the scheduling request indicative, at least in part, of a UE operation of the one or more operations, and means for performing a network operation corresponding to the UE operation that is in accordance with the value of the scheduling request.

A non-transitory computer-readable medium storing code for wireless communication at a network entity is described. The code may include instructions executable by a processor to output first control information indicative of a correspondence between one or more operations at a UE and at least one or more candidate values of a scheduling request, obtain the scheduling request in accordance with the first control information, a value of the scheduling request indicative, at least in part, of a UE operation of the one or more operations, and perform a network operation corresponding to the UE operation that is in accordance with the value of the scheduling request.

Some examples of the method, apparatuses, and non-transitory computer-readable medium described herein may further include operations, features, means, or instructions for obtaining one of a BSR, a DSR, an ESR, or combinations thereof in accordance with the value of the scheduling request and the correspondence.

In some examples of the method, apparatuses, and non-transitory computer-readable medium described herein, outputting, as part of the first control information, an indication of different reports or different report formats as the one or more operations at the UE, the one or more candidate values of the scheduling request each associated with a respective report or report format in accordance with the correspondence.

In some examples of the method, apparatuses, and non-transitory computer-readable medium described herein, the different report formats to include one or more of a first BSR which includes a first table, a second BSR which includes a second table different from the first table, or a third BSR which includes a two-part table.

In some examples of the method, apparatuses, and non-transitory computer-readable medium described herein, outputting, as part of the first control information, an indication of different start indices of a report of the UE as the one or more operations at the UE, the one or more candidate values of the scheduling request each associated with a respective start index in accordance with the correspondence.

Some examples of the method, apparatuses, and non-transitory computer-readable medium described herein may further include operations, features, means, or instructions for obtaining a MAC-CE indicative of an ESR in accordance with the value of the scheduling request and the correspondence, the MAC-CE also indicative of a BSR or report separate from the BSR.

Some examples of the method, apparatuses, and non-transitory computer-readable medium described herein may further include operations, features, means, or instructions for cancelling a PDCCH skip procedure in accordance with the value of the scheduling request and the correspondence.

Some examples of the method, apparatuses, and non-transitory computer-readable medium described herein may further include operations, features, means, or instructions for switching between operations in a first SSSG to operations in a second SSSG in accordance with the value of the scheduling request and the correspondence.

Some examples of the method, apparatuses, and non-transitory computer-readable medium described herein may further include operations, features, means, or instructions for switching between a first communications state to a second communications state in accordance with the value of the scheduling request and the correspondence.

In some examples of the method, apparatuses, and non-transitory computer-readable medium described herein, obtaining, via L1 resources or L2 resources, a MAC-CE that requests to operate in a first SSSG, to skip one or more PDCCH resources, or to operate in a first communications state, the request of the MAC-CE being in accordance with the value of the scheduling request and the correspondence.

In some examples of the method, apparatuses, and non-transitory computer-readable medium described herein, outputting control signaling indicating the L1 resources or the L2 resources for transmission of the MAC-CE.

Some examples of the method, apparatuses, and non-transitory computer-readable medium described herein may further include operations, features, means, or instructions for obtaining a BSR that includes a second value, the correspondence to be further between the UE operation and a combination of the value of the scheduling request and the second value of the BSR and performance of the network operation that corresponds to the UE operation to be further in accordance with the combination of the value of the scheduling request and the second value of the BSR.

Some examples of the method, apparatuses, and non-transitory computer-readable medium described herein may further include operations, features, means, or instructions for obtaining one of a DSR, an ESR, an indication of a SSSG switch, or of a PDCCH skip procedure update, in combination with the BSR in accordance with the value of the scheduling request, the second value of the BSR, and the correspondence.

In some examples of the method, apparatuses, and non-transitory computer-readable medium described herein, the DSR indicative of one of a set of multiple values associated with the DSR based on the combination of the value of the scheduling request, the second value of the BSR, and the correspondence.

In some examples of the method, apparatuses, and non-transitory computer-readable medium described herein, the DSR indicative that a remaining PDB, a wait time of an uplink message of the UE, or both satisfy one or more delay thresholds based on the combination of the value of the scheduling request, the second value of the BSR, and the correspondence.

In some examples of the method, apparatuses, and non-transitory computer-readable medium described herein, the ESR indicative of one of a set of multiple values associated with the ESR based on the combination of the value of the scheduling request, the second value of the BSR, and the correspondence.

In some examples of the method, apparatuses, and non-transitory computer-readable medium described herein, the ESR indicative of one of a charging rate of the UE, a charging request of the UE, or a combination thereof based on the combination of the value of the scheduling request, the second value of the BSR, and the correspondence.

In some examples of the method, apparatuses, and non-transitory computer-readable medium described herein, outputting, as part of the first control information, an indication that the scheduling request may be associated with a reduced quantity of LCGs, the value of the scheduling request indicative that a BSR may be to include information associated with the reduced quantity of LCGs and obtaining the BSR that includes the information associated with the reduced quantity of LCGs in accordance with the value of the scheduling request and the correspondence, a header of the BSR indicative of one or more unused portions of the BSR.

In some examples of the method, apparatuses, and non-transitory computer-readable medium described herein, the one or more unused portions of the BSR to include the information associated with the reduced quantity of LCGs, the information to include an ESR associated with each of the reduced quantity of LCGs, a DSR associated with each of the reduced quantity of LCGs, the BSR associated with each of the reduced quantity of LCGs, or a combination thereof.

In some examples of the method, apparatuses, and non-transitory computer-readable medium described herein, each LCG of the reduced quantity of LCGs to be associated with a respective priority.

In some examples of the method, apparatuses, and non-transitory computer-readable medium described herein, the information associated with the reduced quantity of LCGs to be jointly encoded in the one or more unused portions of the BSR.

In some examples of the method, apparatuses, and non-transitory computer-readable medium described herein, a first unused portion of the one or more unused portions of the BSR to include a codeword indicative of at least a type of the information included in the one or more unused portions of the BSR, a format of the information included in the one or more unused portions of the BSR, a table associated with the information included in the one or more unused portions of the BSR, or a combination thereof.

In some examples of the method, apparatuses, and non-transitory computer-readable medium described herein, the scheduling request to include at least two bits of information.

In some examples of the method, apparatuses, and non-transitory computer-readable medium described herein, outputting second control information that indicates a set of PUCCH resources, obtaining, via a resource of the set of PUCCH resources, uplink control information indicative of a type of a report to be transmitted via a MAC-CE, and obtaining the MAC-CE that includes the report in accordance with the uplink control information.

Some examples of the method, apparatuses, and non-transitory computer-readable medium described herein may further include operations, features, means, or instructions for outputting a request for the UE to report at least one of a set of multiple reports, obtaining an indication that the UE may be to transmit a first report of the set of multiple reports and a first format of the first report, the first format of the first report to be based on a quantity of bits associated with a set of multiple LCGs at the UE, and obtaining the first report formatted in accordance with the indication.

In some examples of the method, apparatuses, and non-transitory computer-readable medium described herein, performance of the network operation to be in accordance with a duration of a timer.

Some examples of the method, apparatuses, and non-transitory computer-readable medium described herein may further include operations, features, means, or instructions for obtaining a message that includes a request to alter the duration of the timer and outputting a second message to alter the duration of the timer based on the request, performance of the network operation to be based on the second message to alter the duration of the timer.

In some examples of the method, apparatuses, and non-transitory computer-readable medium described herein, the network operation to be at least a reception of one of a BSR, a DSR, or an ESR, and the value of the scheduling request to be based on a respective priority associated with each of the BSR, the DSR, and the ESR.

In some examples of the method, apparatuses, and non-transitory computer-readable medium described herein, one of the one or more candidate values of the scheduling request included in the correspondence being zero.

### BRIEF DESCRIPTION OF THE DRAWINGS

FIG. 1 shows an example of a wireless communications system that supports scheduling request-indicated reporting enhancements in accordance with one or more aspects of the present disclosure.

FIG. 2 shows an example of a network architecture that supports scheduling request-indicated reporting enhancements in accordance with one or more aspects of the present disclosure.

FIG. 3 shows an example of a wireless communications system that supports scheduling request-indicated reporting enhancements in accordance with one or more aspects of the present disclosure.

FIG. 4A, FIG. 4B, and FIG. 4C show examples of wireless communications systems that support scheduling request-indicated reporting enhancements in accordance with one or more aspects of the present disclosure.

FIG. 5 shows an example of a wireless communications system that supports scheduling request-indicated reporting enhancements in accordance with one or more aspects of the present disclosure.

FIG. 6A and FIG. 6B show examples of BSRs that support scheduling request-indicated reporting enhancements in accordance with one or more aspects of the present disclosure.

FIG. 7 shows an example of a process flow that supports scheduling request-indicated reporting enhancements in accordance with one or more aspects of the present disclosure.

FIGS. 8 and 9 show block diagrams of devices that support scheduling request-indicated reporting enhancements in accordance with one or more aspects of the present disclosure.

FIG. 10 shows a block diagram of a communications manager that supports scheduling request-indicated reporting enhancements in accordance with one or more aspects of the present disclosure.

FIG. 11 shows a diagram of a system including a device that supports scheduling request-indicated reporting enhancements in accordance with one or more aspects of the present disclosure.

FIGS. 12 and 13 show block diagrams of devices that support scheduling request-indicated reporting enhancements in accordance with one or more aspects of the present disclosure.

FIG. 14 shows a block diagram of a communications manager that supports scheduling request-indicated reporting enhancements in accordance with one or more aspects of the present disclosure.

FIG. 15 shows a diagram of a system including a device that supports scheduling request-indicated reporting enhancements in accordance with one or more aspects of the present disclosure.

FIGS. 16 through 19 show flowcharts illustrating methods that support scheduling request-indicated reporting enhancements in accordance with one or more aspects of the present disclosure.

### DETAILED DESCRIPTION

In some wireless communications systems, a UE may periodically transmit a scheduling request to request resources for one or more uplink transmissions. In order to facilitate such communications, a network entity may allocate a resource set dedicated for scheduling requests by the UE. As such, if the UE has data to transmit, the UE may transmit a scheduling request during a resource occasion of the allocated resource set; otherwise, the UE may skip transmission during the resource occasion. For example, in order to indicate a positive scheduling request (e.g., a bit value of ‘1’), the UE may transmit a sequence representing the logical value of ‘1’ during the resource occasion. Alternatively, to indicate a negative scheduling request (e.g., no scheduling request), the UE may refrain from transmitting during the resource occasion. That is, the UE may refrain from transmitting a sequence (e.g., signal) during a resource occasion of the resource set in order to indicate a negative scheduling request. Nevertheless, the UE could also transmit a sequence representing the logical value of ‘0’ during the resource occasion. Because a negative scheduling request may be indicated by a UE simply skipping a transmission during an allocated resource occasion, the option of transmitting a scheduling request with logical value of ‘0’ is not generally used. However, in such cases, by not using the option of transmitting the scheduling request with the logical value of ‘0’, the UE may not be able to utilize the unused codepoint in the wireless communications system. Thus, it may be desirable for the UE to transmit a scheduling request (e.g., a sequence or signal) that represents the logical value ‘0’ for various other purposes in the wireless communications system.

The techniques, methods, and devices described herein may enable a UE to implement reporting enhancements via a scheduling request. For example, the UE may receive, from the network entity, first control information that includes a correspondence between one or more candidate values (e.g., candidate values of either a ‘1’ or a ‘0’) of a scheduling request and various UE operations. As an illustrative example, the correspondence may indicate that a scheduling request representing a logical value of ‘1’ indicates that the UE may subsequently transmit a BSR, while a logical value of ‘0’ indicates that the UE may subsequently transmit one of a DSR or an ESR. In this way, the UE may transmit a scheduling request, where a value of the scheduling request indicates to the network entity one of various UE operations according to the correspondence.

Additionally, or alternatively, the first control information may include a correspondence between a combination of the candidate values of the scheduling request and unused values of a BSR. For example, the correspondence may indicate that a combination of a specific value of the scheduling request and a specific value of the BSR indicates a DSR, an ESR, or even another UE operation (e.g., to skip one or more PDSCH resources, switch between SSSGs, switch communication states, or the like). In this way, the UE and network entity may leverage one or more unused codepoints of the BSR and the scheduling request in order to indicate various UE operations.

As described herein, first control information may be an example of radio resource control (RRC) signaling. L1 or L2 signaling, MAC-CE signaling, or the like. A correspondence may refer to a mapping, an association, a correlation, or the like between the various values described herein and the one or more UE operations. The one or more candidate values of the scheduling request may refer to various logical values that a sequence of the scheduling request represents. In some examples, such logical values may include a logical value of ‘0’ or a logical value of ‘1.’ The one or more UE operations and network operations may be examples of various actions or signaling that the UE and network entity may perform. Such operations may include transmitting a BSR, DSR, or ESR, switching between SSSGs, skipping various PDSCH resources, switching between communication states, or the like. The value of the scheduling request may refer to logical value represented by the physical sequence transmitted as part of the scheduling request.

That is, as described herein, the network entity may configure a correspondence between each candidate value of the scheduling request and each operation, such that there may be a one-to-one correspondence between candidate values of the scheduling request and operations. For example, the network entity may configure the correspondence such that a first operation corresponds to a logical value of ‘0’ of the scheduling request and a second operation corresponds to a logical value of ‘1’ of the scheduling request. Further, the network entity may configure a correspondence between a combination of values of the scheduling request and BSR and operations, such that there is a one-to-one mapping between the combination of values and each operation. For example, the network entity may configure the correspondence such that a first operation corresponds to a combination of logical value of ‘0’ of the scheduling request and a logical value of ‘0’ at the BSR and a second operation corresponds to a combination of logical value of ‘0’ of the scheduling request and a logical value of ‘255’ at the BSR. In this way, the network entity may configure one-to-one mappings, or correspondences, between each candidate value of the scheduling request and the operations.

By implementing the techniques described herein, the UE and the network entity may reduce signaling overhead associated with various UE operations. For example, by leveraging unused codepoints of the scheduling request (e.g., transmitting a sequence indicating a logical value of ‘0’, such as an OFDM sequence or an on-off keying (OOK) sequence), BSR, or both, the UE may be able to indicate a BSR, a DSR, or an ESR based on the values of the scheduling request and the BSR. Further, the UE may be able to indicate various UE operations, such as PDSCH resource skipping, SSSG switching, communication state switching, or the like, which may reduce signaling overhead associated with such operations. As such, reducing signaling overhead between the UE and the network entity may result in decreased latency, increased channel capacity, and improved coordination between devices.

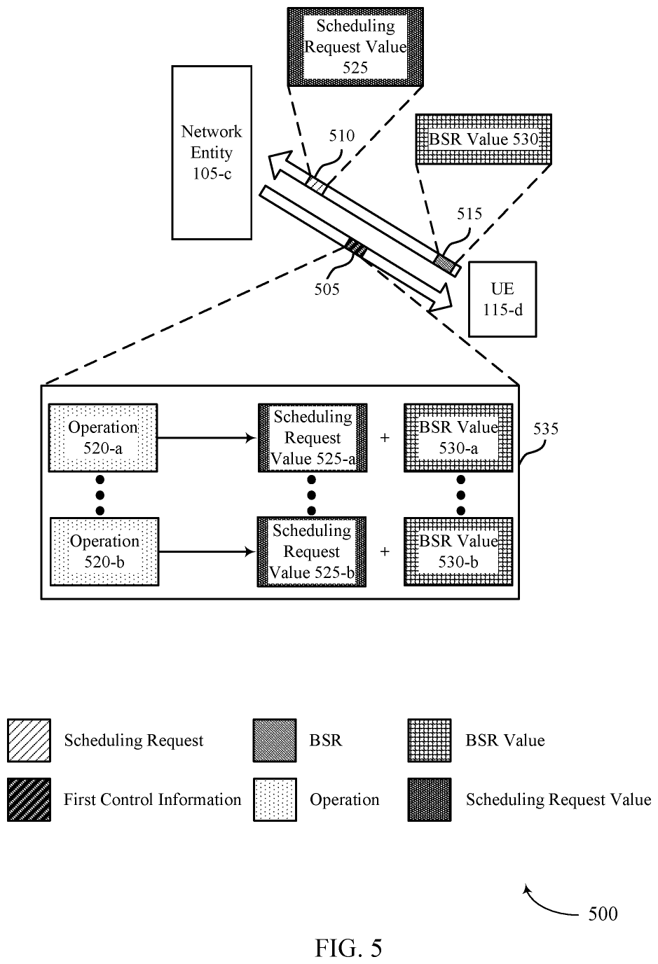

Further, by leveraging unused codepoints of both the scheduling request and the BSR, the network entity may be able to indicate up to four operations that correspond to four different combinations of the value of the scheduling request and the value of the BSR (e.g., (‘0’, ‘0’), (‘0’, ‘255’), (‘1’, ‘0’), and (‘1’, ‘255’) as described herein with reference to FIG. 5). As such, the UE may be able to choose between the four operations, such as transmitting a BSR, DSR, ESR, or performing PDSCH resource skipping, SSSG switching, or the like. In this way, the UE and the network entity may experience a reduction in signaling overhead to indicate such operations, resulting in reduced latency and efficient use of communication resources.

Aspects of the disclosure are initially described in the context of wireless communications systems. Aspects of the disclosure are further described in the context of BSR formats and process flows. Aspects of the disclosure are further illustrated by and described with reference to apparatus diagrams, system diagrams, and flowcharts that relate to scheduling request-indicated reporting enhancements.

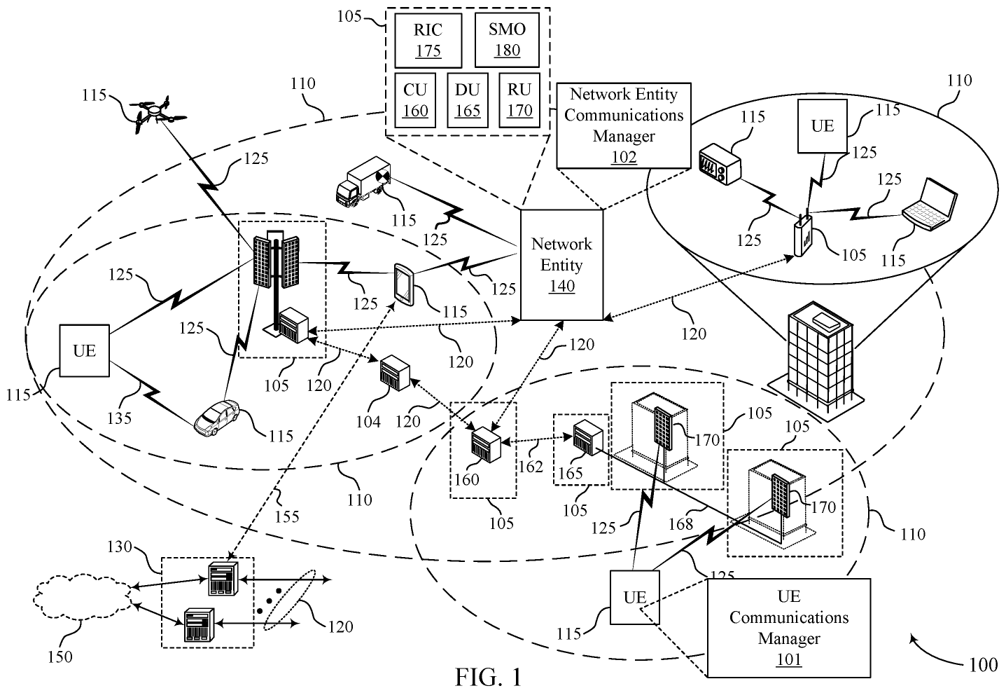

FIG. 1 shows an example of a wireless communications system 100 that supports scheduling request-indicated reporting enhancements in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein. The network entities 105 may include a network entity communications manager 102, which may be configured to support communications in the wireless communications system 100. Similarly, the UEs 115 may include a UE communications manager 101, which may be configured to support communications in the wireless communications system 100.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1 c, F1 u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support scheduling request-indicated reporting enhancements as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as OFDM DFT-S-OFDM). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_s=1/((Δf_max·N_f)) seconds, for which Δf_max may represent a supported subcarrier spacing, and N_f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Techniques described herein, in addition to or as an alternative to be carried out between UEs 115 and base stations 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 175 is flexible and as such gives rise to numerous permutations of different functionalities depending upon which functions (e.g., MAC functions, baseband functions, radio frequency functions, and any combinations thereof) are performed at the CU 160, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more base stations 105 may include CUs 160, DUs 165, and RUs 170 and may be referred to as donor base stations 105 or IAB donors. One or more DUs 165 (e.g., and/or RUs 170) associated with a donor base station 105 may be partially controlled by CUs 160 associated with the donor base station 105. The one or more donor base stations 105 (e.g., IAB donors) may be in communication with one or more additional base stations 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station 105 may additionally or alternatively be performed by components of the disaggregated RAN architecture (e.g., IAB nodes, DUs, CUs, etc.).

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some cases, the UE 115 may transmit various reports to the network entity 105, such that the network entity 105 may schedule resources, indicate for the UE to switch between communication states, indicate for the UE to skip one or more resources, among various other operation based on such reports. In one example, the UE 115 may transmit a BSR indicating one or more metrics of a data buffer at the UE 115. For example, for regular and periodic BSRs, if more than one logical channel group (LCG) at the UE 115 has data available for transmission in a transmission time interval (TTI) where the BSR is transmitted, the UE 115 may report a long BSR; otherwise, the UE 115 may report a short BSR.

In some cases, the UE 115 may pad (e.g., add additional bits to) a BSR based on the size of the data at the UE 115 and a quantity of padding bits. That is, for padding a BSR, if the quantity of padding bits is equal to or greater than a size of the short BSR plus a sub header of the short BSR but the quantity of padding bits is smaller than the size of the long BSR plus the sub header of the long BSR and if more than one LCG has data available for transmission in the TTI where the BSR is transmitted, then the UE 115 may report a truncated BSR of the LCG associated with the highest priority logical channel (e.g., relative to the other logical channels) with data available for transmission; otherwise, the UE 115 may report a short BSR. If the quantity of padding bits is equal to or larger than the size of the long BSR plus the sub header of the long BSR, then the UE 115 may report the long BSR.

In such cases, if a regular BSR is triggered at the UE 115, then a MAC layer of the UE 115 may trigger a scheduling request procedure at the UE 115. If the UE 115 has a valid physical uplink control channel (PUCCH) resource for transmission of the scheduling request, then the UE 115 may transmit the scheduling request; otherwise, a random access procedure may be triggered at the UE 115. As such, when a BSR other than regular BSR is triggered at the UE 115, a scheduling request may not be triggered at the UE 115 (e.g., UE 115 may not transmit a scheduling request).

Table 1 may describe the structure and size of a short BSR and a short truncated BSR. For example, the short BSR and the short truncated BSR may include eight bits of information, where three bits of information may be used to identify the LCG associated with the BSR (e.g., the LCG identifier (ID)) and the remaining five bits may be used for the BSR for the LCG as described in Table 1. For example, the structure and size of a short BSR and a short truncated BSR may be the same. The difference between the short SR and the short truncated BSR is that a short truncated BSR may include information when a single LCG has data to transfer, while the short truncated BSR LCG may include information regarding the LCG which includes the highest priority logical channel (e.g., relative to various other logical channels) when multiple LCG have data to transfer. That is, the UE 115 may transmit a short BSR in cases when the UE 115 has data for a single LCG to transmit, while the UE 115 may transmit a short truncated BSR in cases when the UE 115 reports the BSR for an LCG with the highest priority relative to the other LCGs, where the other LCGs may also have data to transmit. In some examples, the UE 115 may include a DSR in a portion of the five bits of the BSR.

TABLE 1

| | |
|---|---|
| LCG ID (3 Bits) | BSR (5 Bits) |

Table 2 may describe the structure and size of a long BSR and a long truncated BSR. The UE 115 may transmit the long BSR and the long truncated BSR via MAC-CE signaling, where each report may have the same format but be variable in size. For example, the first byte of the long BSR and the long truncated BSR may represent the LCG IDs of the logical channels at the UE 115, while the remaining bytes represent, or otherwise include, the BSR for each LCG ID. In such cases, the UE 115 may use eight bits (e.g., 1 byte) for the long BSR and the long truncated BSR, where the eight bits may correspond to 28, or 256, indexes in order to accommodate a larger buffer status of 81,338,368 bytes.

TABLE 2

| LCG | LCG | LCG | LCG | LCG | LCG | LCG | LCG |
|---|---|---|---|---|---|---|---|
| 7 | 6 | 5 | 4 | 3 | 2 | 1 | 0 |

BSR LCG 0
BSR LCG 1
. . .
BSR LCG 7

In another example, the UE 115 may transmit an ESR to the network entity 105. For example, an ESR element may include at least one of energy information of the UE 115, energy state information (e.g., or communication state information), an energy request report, or a combination thereof. For example, the UE 115 may transmit, via the energy information as part of the ESR, a charging rate profile, a discharging rate profile, an energy level profile, a quantity of energy (e.g., how much energy) that may be used by the UE 115 for transmission of a signal or reception of a signal, or any combination thereof.

In some cases, the UE 115 may transmit, via the ESR, one or more energy states of the UE 115, where each state may be associated with capabilities of the UE, respective RRC configurations, or both. For example, in very low power devices (including energy harvesting (EH) devices), the UE 115 may indicate a communication state or an energy state via the ESR, where each state may be associated with one of: an RRC configuration to be used between the UE 115 and the network entity 105, a physical downlink control channel (PDCCH) skipping operation (e.g., excluding one or more DCI formats, but including energy control signals), PDCCH skipping of legacy formats of one or more waveforms, switching to on-off keying (OOK) based signaling or using lower power formats for signaling, an uplink capability of the UE 115, a downlink capability of the UE 115, support of a subset of physical channels, support for at least one of L1, L2, and layer 3 (L3) signaling, skipping (e.g., disabling, suspending, deactivating) a downlink channel, skipping (e.g., disabling, suspending, deactivating) an uplink channel, allowing restrictive time gap and timelines between various signals based on a bandwidth part of the various signals, a quantity of resource elements, a type of signal to be communicated between the UE 115 and the network entity 105 (e.g., data vs reference signal vs sync signal), skipping (e.g., disabling, suspending, deactivating) all downlink channels and communication, skipping (e.g., disabling, suspending, deactivating) all uplink channels and communication, an SSSG state, or a combination thereof.

In some cases, each state may be associated with a respective sequence or pattern of skipping various resources and SSSG switching. As an illustrative example, during a first energy or communication state, the UE 115 may skip various resource occasions for duration of n1, operate in a first SSSG for a duration of n2, skip various resource occasions for duration of n3, and repeat such processes until a new indication or for a duration of time. Further, each state may be associated with a respective pattern of supported uplink channels, downlink channels, or an activity. In some cases, a first state may be associated with skipping (e.g., disabling, suspending, deactivating) all communications between the UE 115 and the network entity 105.

In some cases, the UE 115 may transmit an energy request report as part of the ESR, where the energy request report may include a request for the network entity 105 to use an EH profile, a request for the network entity 105 to operate for a duration of time, a request for the network entity 105 to use a configuration for energy, or a combination thereof. In such cases, the UE 115 may transmit the energy request report as part of the ESR if the network entity 105 supplies wireless energy to the UE 115, if energy is coming from various other EH sources and technologies, or both.

In another example, the UE 115 may transmit a DSR or a statistical DSR (SDR) to the network entity 105. For example, the UE 115 may transmit the DSR to the network entity 105, where the DSR may include at least one of a wait time (e.g., Twait) for an uplink packet at a buffer of the UE 115 for a LCG, a remaining packet delay budget (PDB) at the UE 115, an indication of a quantity of time (e.g., how much time delay) until expiration of a data packet at the UE 115, or a combination thereof. Twait may be the uplink PDCP queueing delay at the UE 115. For example, the uplink PDCP queueing delay (e.g., Twait) may be the delay from the packet arrival time at an upper service access point (SAP) of the PDCP until an uplink grant to transmit the packet is available at the UE 115, which includes the delay the UE 115 experiences from receiving the granted resources (e.g., from sending a scheduling request or RACH message to receiving the first resource grant).

Further, the UE 115 may transmit a SDR to the network entity 105 in addition to, or separate from, the DSR, where the SDR may include at least one of an average wait time (e.g., average Twait) of uplink packets at the buffer of the UE 115, a variance of the wait time, a cumulative distribution function (CDF) of the wait time, or a combination thereof. Further, the SDR may include an average remaining PDB, a variance of the PDB, a CDF of the PDB, or a combination thereof. In such examples, the statistical values included in the SDR may be for a single LCG or across a set of LCGs.

In some cases, the UE 115 may periodically transmit a scheduling request to request resources for one or more uplink transmissions. In order to facilitate such communications, a network entity 105 may allocate a resource set dedicated for scheduling requests by the UE 115. As such, if the UE 115 has data to transmit, the UE 115 may transmit a scheduling request during a resource occasion of the allocated resource set; otherwise, the UE 115 may skip transmission during the resource occasion. For example, in order to indicate a positive scheduling request (e.g., a ‘1’), the UE 115 may transmit a sequence representing the logical value of ‘1’ during the resource occasion. Alternatively, to indicate a negative scheduling request (e.g., no scheduling request), the UE 115 may refrain from transmitting during the resource occasion. That is, the UE 115 may refrain from transmitting a sequence (e.g., signal) during a resource occasion of the resource set in order to indicate a negative scheduling request. Thus, it may be desirable for the UE 115 to transmit a scheduling request (e.g., a sequence or signal) that represents the logical value ‘0’ for various other purposes in the wireless communications system.

The techniques, methods, and devices described herein may enable a UE 115 to implement reporting enhancements via a scheduling request. For example, the UE 115 may receive, from the network entity 105, first control information that includes a correspondence between one or more candidate values of a scheduling request and various UE 115 operations. As an illustrative example, the correspondence may indicate that a scheduling request with a logical value of ‘1’ indicates that the UE 115 may subsequently transmit a BSR, while a logical value of ‘0’ indicates that the UE 115 may subsequently transmit one of a DSR or an ESR. In this way, the UE 115 may transmit a scheduling request, where a value of the scheduling request indicates to the network entity 105 one of various UE 115 operations according to the correspondence.

Additionally, or alternatively, the first control information may include a correspondence between a combination of the candidate values of the scheduling request and unused values of a BSR. For example, the correspondence may indicate that a combination of the value of the scheduling request and the BSR indicates a DSR, an ESR, to skip one or more PDSCH resources, switch between SSSGs, communication state switching, or the like. In this way, the UE 115 and network entity 105 may leverage one or more unused codepoints of the BSR and the scheduling request in order to indicate various UE 115 operations.

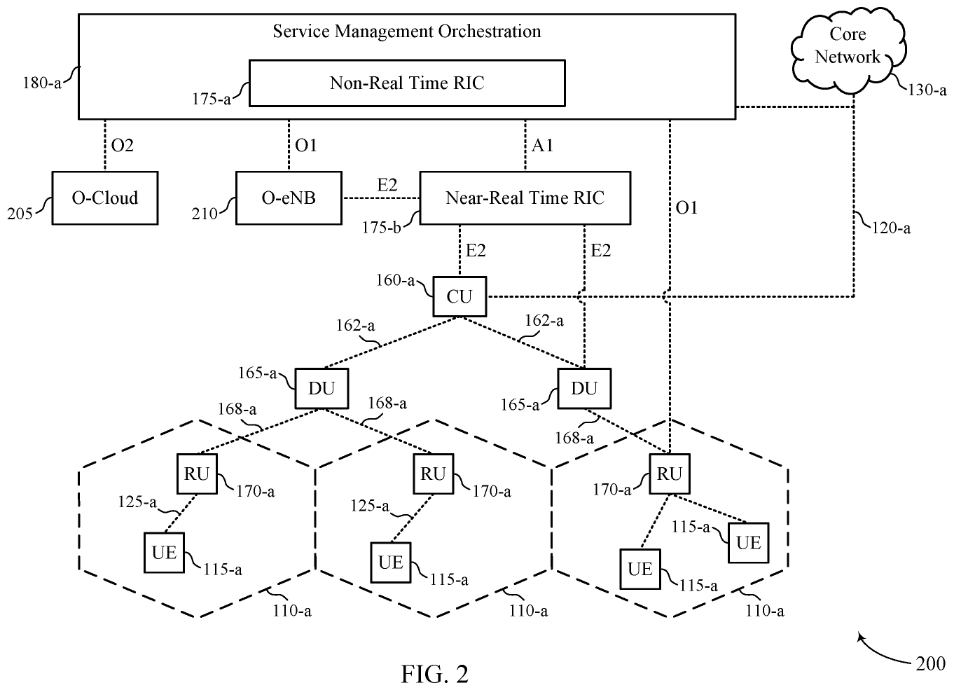

FIG. 2 shows an example of a network architecture 200 (e.g., a disaggregated base station architecture, a disaggregated RAN architecture) that supports scheduling request-indicated reporting enhancements in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a. RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

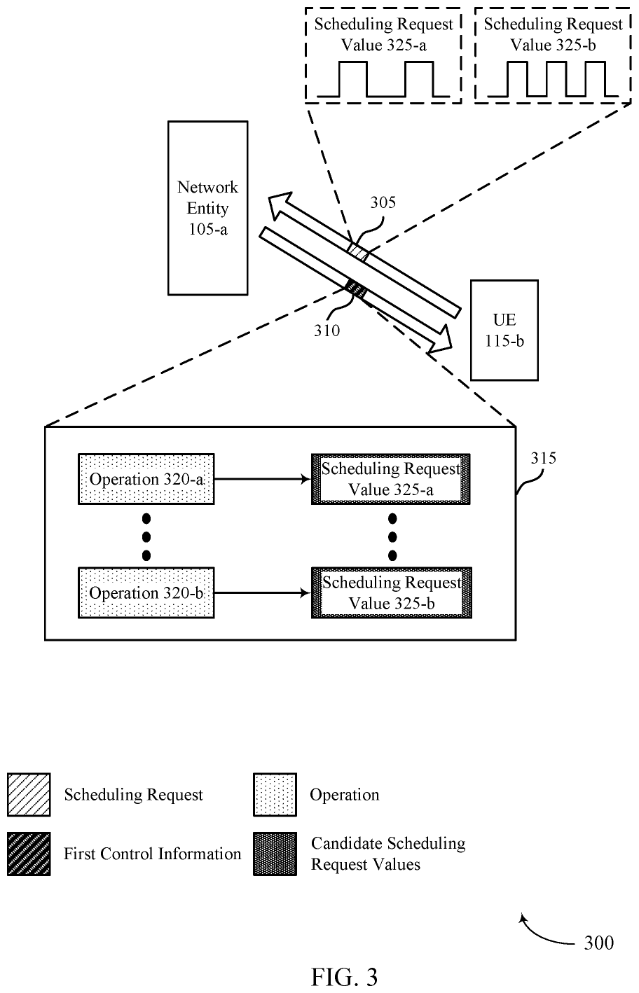

FIG. 3 shows an example of a wireless communications system 300 that supports scheduling request-indicated reporting enhancements in accordance with one or more aspects of the present disclosure. Aspects of the wireless communications system 300 may implement, or be implemented by, aspects of the wireless communications system 100 and the network architecture 200 as described herein with reference to FIGS. 1 and 2. For example, the wireless communications system 300 may include a UE 115-b and a network entity 105-a, which may be examples of UEs 115 and network entities 105 as described herein. The techniques described in the context of the wireless communications system 300 may enable a UE 115-b and a network entity 105-a to indicate one or more operations 320 via a scheduling request value 325 of a scheduling request 305.

In some cases, the UE 115-b may periodically transmit the scheduling request 305 to request resources for one or more uplink transmissions. In order to facilitate such communications, the network entity 105-a may allocate a resource set dedicated for transmission of the scheduling request 305 by the UE 115-b. As such, if the UE 115-b has data to transmit, the UE 115-b may transmit the scheduling request 305 during a resource occasion of the allocated resource set; otherwise, the UE 115-b may skip transmission during the resource occasion. For example, in order to indicate a positive scheduling request 305 (e.g., a ‘1’), the UE 115-b may transmit a sequence representing a scheduling request value 325 of ‘1’ during the resource occasion. Alternatively, to indicate a negative scheduling request 305 (e.g., no scheduling request), the UE 115-b may refrain from transmitting during the resource occasion. That is, the UE 115-b may refrain from transmitting a sequence (e.g., signal) during a resource occasion of the resource set in order to indicate a negative scheduling request 305. Thus, it may be desirable for the UE 115-b to transmit the scheduling request 305 (e.g., a sequence or signal) that includes the scheduling request value 325 of ‘0’ for various other purposes in the wireless communications system 300.

Further, in some cases, the network entity 105-a and the UE 115-b may implement techniques in order to enhance buffer status reporting at the UE 115-b for one or more applications, such as extended reality (XR) or sixth generation (6G) purposes. Such BSR enhancements may include introducing one or more tables (e.g., defined in a standard body) in order to reduce quantization errors (e.g., for high bit rates), where such tables may impact BSR formatting. In such cases, the UE 115-b and the network entity 105-a may use, or otherwise implement, the one or more tables (e.g., tables customized or intended for XR and 6G applications) in addition to the current legacy BSR tables. As such, techniques may be desired for the UE 115-b to indicate a format of the BSR associated with the one or more tables and for the UE 115-b to indicate whether the UE 115-b is to report the BSR versus other reports, such as a DSR, an ESR, or both.

The techniques described herein may enable the network entity 105-a and the UE 115-b to leverage one or more unused codepoints (e.g., a physical sequence of the scheduling request 305 indicating a scheduling request value 325 of ‘0’) to indicate an operation 320-a (e.g., UE operations and network operations). Further, the techniques described herein may enhance the design and reporting of BSRs, DSRs, ESRs, or both, and enable the UE 115-b and the network entity 105-a to provide format indications, indications to use a first BSR table from a set of BSR tables (e.g., which may be defined by a standard or signaled from the network entity 105-a), among other enhancements. Such techniques (e.g., scheduling request 305 and BSR enhancements) may be intended for XR and 6G applications, including EH applications, but may not be excluded from use in other communication applications. That is, the techniques described herein may enable the UE 115-b to indicate, to the network entity 105-a, an operation 320-a that the UE 115-b is to perform based on a scheduling request value 325-a (e.g., value of ‘0’) indicated in the scheduling request 305.

For example, the network entity 105-a may transmit first control information 310 that indicates a correspondence 315 between each operation 320 and respective candidate scheduling request values 325. That is, the network entity 105-a may configure each scheduling request configuration (e.g., resource set) and each occasion of the scheduling request 305 within the configuration with a respective correspondence 315, where the respective correspondences 315 may indicate a mapping between the scheduling request value 325 and operation 320 that may be reported during such scheduling request configurations and occasions. In this way, the network entity 105-a may configure a one-to-one correspondence between the operation 320-a and the scheduling request value 325-a (e.g., ‘0’) and the operation 320-b and the scheduling request value 325-b (e.g., ‘1’).

That is, if the network entity 105-a transmits a resource set indicating multiple scheduling request resources (e.g., occasions), the network entity 105-a may also indicate a respective one-to-one correspondence 315 between respective candidate scheduling request values 325 and the operations 320 for each resource (e.g., occasion) for the scheduling request 305. Alternatively, if the network entity 105-a transmits an indication of a resource set for the transmission of the scheduling request 305, the network entity 105-a may also indicate a single correspondence 315 that is associated with each resource (e.g., occasion) of the resource set (e.g., resource configuration). In this way, the UE 115-b may select an operation 320 of the one or more operations 320 and indicate the selection to the network entity 105-a via the scheduling request value 325.

In some examples, the correspondence 315 (e.g., configuration) may indicate that the scheduling request value 325-a (e.g., a value of ‘0’) is associated with a reporting operation. For example, the scheduling request value 325-a may correspond to the operation 320-a, where the operation 320-a may be the subsequent transmission of a BSR and a DSR via the same report by the UE 115-b. Alternatively, the scheduling request value 325-a may correspond to the operation 320-a, where the operation 320-a may be that the UE 115-b is to transmit one of the DSR or the ESR as part of a subsequent BSR. Further, the scheduling request value 325-a may correspond to the operation 320-a, where the operation 320-a may be associated with a table, a format (e.g., such as a short BSR format, short truncated BSR format, long BSR format, or a long truncated BSR format), or a start index associated with the BSR. As such, the UE 115-b may indicate the table, format, or start index for a BSR via the scheduling request value 325-a and subsequently transmit the BSR in accordance with the scheduling request value 325-a.

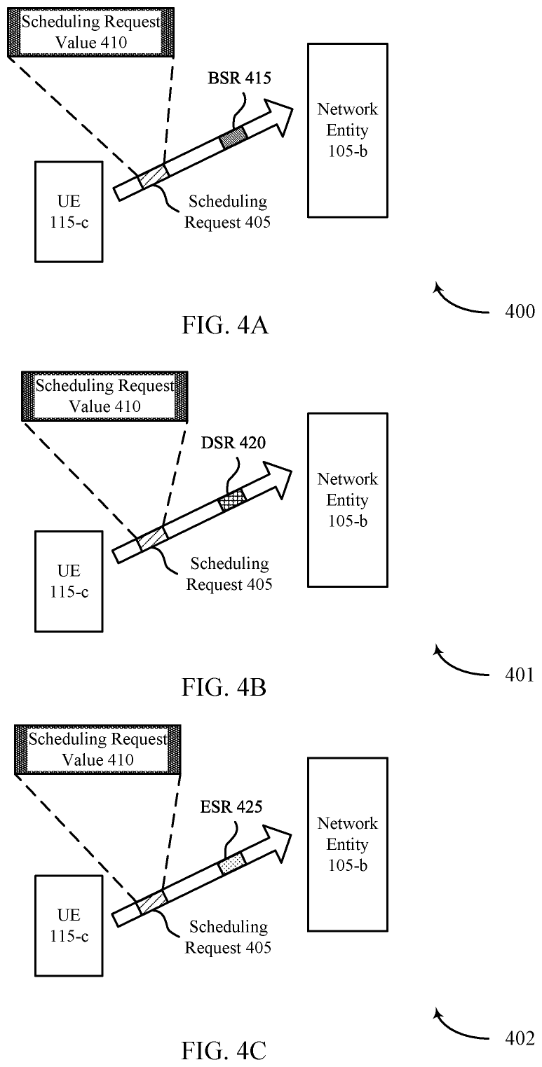

In some examples, prior to receiving the first control information 310, the network entity 105-a may transmit RRC signaling. MAC-CE signaling, or both in order to configure the UE 115-b with multiple formats, report types, or both. In such examples, the UE 115-b may determine a report type or a format out of a possible two report types or two formats based on the RRC signaling or MAC-CE signaling and transmit the scheduling request 305, where the scheduling request value 325-a may indicate which format or report type the UE 115-b has determined to transmit. As an illustrative example, the network entity 105 may indicate, via RRC signaling or MAC-CE signaling, a first format, such as a short BSR format, and a second format, such as a short truncated BSR format for a BSR at the UE 115-b. In such examples, the network entity 105-b may indicate, via the correspondence 315, that the scheduling request value 325-a is associated with the first format (e.g., short BSR as described herein with reference to FIG. 1 and Tables 1 and 2), while the scheduling request value 325-b is associated with the second format. In this way, the UE 115-b may determine which format to use for the transmission of the BSR and indicate the determination to the network entity 105-b, accordingly. Such operations 320 (e.g., indicating the reporting of BSR. ESR, or DSR, table associated with the BSR, format associated with the BSR, or the like) may be further described herein with reference to FIGS. 4A, 4B, and 4C.

In some examples, the scheduling request value 325-a may correspond to a resource management operation 320. For example, the scheduling request value 325-a (e.g., value of ‘0’ or non-zero sequence signal of the scheduling request 305) may correspond to the operation 320-a, where the operation 320-a includes at least one of a cancellation of a PDCCH skipping procedure, that the UE 115-b is to skip one or more PDCCH resources, switch between a first SSSG state (e.g., current SSSG state) to a second SSSG state, switch between a first communication state (e.g., current communications state) to a second communication state, or switch to a default communication state. In some other examples, the scheduling request value 325-a of the scheduling request may be indicative of a duration that the UE 115-b is to skip monitoring a PDCCH. That is, the operation 320-a may include that the UE 115-b is to skip monitoring a PDCCH for the duration of a timer. Similarly, the scheduling request value 325-a may be indicative of a recommended SSSG switching timer. That is, the operation 320-a may be that the UE 115-b is to switch to operating in a first SSSG for a duration of a timer and switch to operating in a default or original SSSG based on expiration of the timer. Although such operations are presented as examples, it should be understood that any UE or network operations may be indicated using the scheduling request value 325-a (e.g., value of ‘0’) via the scheduling request 305.

In some other examples, the scheduling request value 325-a (e.g., value of ‘0’ or non-zero sequence signal of the scheduling request 305) may correspond to the operation 320-a, where the operation 320-a is an indication of whether a subsequent MAC-CE signal is related to communication state switching, PDCCH resource skipping. SSSG switching, or whether the subsequent MAC-CE signaling includes a BSR. DSR, or ESR. In some examples, the scheduling request value 325-a may indicate whether the subsequent MAC-CE signal includes an indication of a current energy state at the UE 115-b, an indication of a current communication state at the UE 115-b, a desired SSSG, an indication of a change to a PDCCH skipping procedure, or the like. That is, the scheduling request value 325-a may be a first stage indication associated with a second stage indication, where the second stage indication may be MAC-CE signaling (e.g., with a reduce quantity of bytes or bits than regular BSR) or a physical layer indication. The UE 115-b may transmit the subsequent MAC-CE based on the scheduling request value 325-a via L1 and L2 resources, which may be configured by the network entity 105-a or pre-configured using L1, L2, or L3 indications.

As an illustrative example, the correspondence 315 may indicate that the scheduling request value 325-a is to be a first stage indication for a MAC-CE signal, where the scheduling request value 325-a (e.g., value of ‘0’) may indicate that the MAC-CE signal may include an indication of a desired operating SSSG. Additionally, the correspondence 315 may indicate that a scheduling request value 325-b (e.g., value of ‘1’) may indicate that the subsequent MAC-CE signal is to include a BSR. As such, UE 115-b may transmit the MAC-CE including the indication of the desired operating SSSG or the BSR based on the scheduling request value 325. In this way, the UE 115-b may provide the network entity 105-a with an indication of a request that is to be included in a subsequent MAC-CE signaling.

In some examples, in order to indicate additional operations 320 via the correspondence 315, the size of the scheduling request 305 may be increased from a single bit of information (e.g., ‘0’ or ‘1’) to at least two bits of information. For example, the UE 115-b and the network entity 105-a may use the scheduling request 305 with additional bits of information, such that the correspondence 315 may include an increased quantity of mappings between operations 320 and the candidate scheduling request values 325. As an illustrative example, if the scheduling request value 325 is increased to two bits of information, then the correspondence 315 may include a mapping between four operations 320 and four candidate scheduling request values 325. In this way, the UE 115-b may indicate, via the scheduling request value 325-a, one of the four operations 320 that is to be performed at the UE 115-b.

In order to support the additional bits to the scheduling request value 325, the UE 115-b and the network entity 105-a may transmit the scheduling request 305 via various PUCCH formats. For example, the UE 115-b may transmit the scheduling request 305 via PUCCH format 0, where the PUCCH format 0 may support multiple cyclic shifts to represent multiple codepoints (e.g., multiple bits), support multiple sequences (e.g., multiple physical signals, each associated with a single bit of information), or a combination thereof. Additionally, or alternatively, in order to support the additional bits of information and multiple codepoints, the UE 115-b may transmit the scheduling request 305 using an advanced PUCCH format, such as PUCCH format 1, PUCCH format 2, PUCCH format 3, or PUCCH format 4. In such examples, the PUCCH formats may be sequence based in order to support the additional bits of the scheduling request 305 or coded using polar codes. Further, the UE 115-b and the network entity 105-b may implement a PUCCH format that may be implemented in order to support sequence based scheduling requests 305, such that additional bits of information may be conveyed via the scheduling request value 325-a.

As such, based on the correspondence between the scheduling request value 325-a (e.g., value ‘0’) and the operation 320-a, the UE 115-b may transmit the scheduling request 305 including the scheduling request value 325-a. In response, the UE 115-b may perform the operation 320-a in accordance with the scheduling request value 325-a and the correspondence 315. In this way, the UE 115-b may indicate the operation 320-a to be performed based on the scheduling request value 325-a.

In some examples, in addition to, or as an alternative to, using the scheduling request 305 for BSR reporting enhancements, the UE 115-b may indicate a type of report (e.g., BSR, DSR, or ESR) or table format to the network entity 105-a via one or more configured grant uplink control information (UCI) transmissions after the transmission of the scheduling request 305. In such examples, the UE 115-b may transmit the UCI including the indication of the type of report, table format, or both based on if a corresponding physical uplink shared channel (PUSCH) transmission includes MAC-CE signaling. Further, in some examples, the UE 115-b may use multiple UCI transmissions to indicate one or more pieces of information related to a next MAC-CE, such as whether the MAC-CE is related to reporting one or more of a BSR, a DSR, or an ESR.

For example, the network entity 105-a may transmit a configured grant (e.g., periodic resources configured for PUCCH transmissions) for use by the UE 115-b. As such, in order to support the BSR enhancements, the UE 115-b may indicate, via one or more UCI transmissions using the resources of the configured grant, whether a subsequent MAC-CE signal is to include a BSR, a DSR, or an ESR. Further, the UE 115-b may indicate, via the UCI transmissions, a report format (e.g., short, short truncated, long, long truncated) associated with the various reports in the MAC-CE. In this way, the UE 115-b may indicate to the network entity 105-a a type of report and format of the type of report to be transmitted in a subsequent MAC-CE via UCI transmissions. Based on transmitting the UCI transmissions, the UE 115-b may transmit the MAC-CE signaling to the network entity 105-a, where the MAC-CE signaling includes a report in accordance with the indications in the UCI transmissions.

In some examples, in order to support the BSR enhancements, the UE 115-b may transmit a BSR, a DSR, or an ESR in accordance with a periodicity or based on a trigger from the network entity 105-a. For periodic BSRs, the UE 115-b may be configured, from the network entity 105-a, with PUCCH resources in order to indicate the type of report that the UE 115-b has or wants to transmit. As such, based on transmitting the indication of the type of report via the periodic PUCCH resources, the UE 115-b may transmit signaling including the report based on the indication.

For triggered BSRs (e.g., aperiodic), the UE 115-b may receive a request from the network entity 105-a to transmit the BSR, where the UE 115-b may transmit the BSR in accordance with the request. In such examples, the network entity 105-a may include, in the request, various reporting options, such that the UE 115-b may select which report to transmit from the various reporting options. For example, the network entity 105-a may request that the UE 115-b transmit a BSR and may also indicate that if the UE 115-b does not have data to transmit, then the UE 115-b is to transmit an ESR. Further, the network entity 105-a may also indicate, via the request, various table formats, such that the UE 115-b may select a table format from the various table formats based on a quantity of bits in the buffer of different LCGs. As such, the network entity 105-a may associate the request with a feedback resource (e.g., PUCCH) in order for the UE 115-b to indicate which report and which format the subsequent signaling may include. In this way, the UE 115-b may be triggered (e.g., receive a request) by the network entity 105-a to transmit the BSR, the DSR, or the ESR.

As an illustrative example of triggered BSR, the network entity 105-a may transmit a request (e.g., trigger) that the UE 115-b is to transmit at least one of a BSR, a DSR, a SDR, or an ESR. In such examples, the network entity 105-a may transmit, as a part of, or separate from, the request, an indication of one or more PUCCH resources, such that the UE 115-b may transmit an indication of which report (e.g., BSR, DSR, SDR, or ESR) and which format (e.g., short, short truncated, long, long truncated) the UE 115-b is to report. As such, the UE 115-b may transmit, via L1 or L2 signaling (e.g., MAC-CE signaling), the report in accordance with the indication via the PUCCH resources.

In some examples, the UE 115-b may perform the operation 320-a (e.g., transmit a BSR, a DSR, a SDR, an ESR) or transmit the scheduling request according to a timer (e.g., a prohibitive timer and a retransmission timer). For example, the UE 115-b may transmit a BSR according to a prohibitive timer and a retransmission timer. As such, the prohibitive timer and retransmission timer for the BSR may also apply to the DSR, the SDR, the ESR, or a combination thereof. Alternatively, the UE 115-b may transmit the DSR, the SDR, and the ESR according to respective timers for each report. In some examples, the network entity 105-a may extend, disable, or shorten (e.g., alter) the prohibitive BSR timer based on an indication from the UE 115-b. For example, the UE 115-b may transmit an indication to alter (e.g., extend, shorten, or disable) the timer. In some other examples, the UE 115-b may indicate to alter the timer based on transmitting a last codepoint in the 8-bit codebook of the BSR (e.g., transmit a BSR index of 255, which is currently reserved). In such examples, if the network entity 105-a receives the BSR with the last codepoint, then the network entity 105-a may transmit an indication to alter the timer. As such, once the timer has been altered (e.g., extended, shortened, or disabled), the UE 115-b may transmit a BSR via a configured or dynamic grant (e.g., PUSCH transmission) or via a MAC-CE associated with a PUSCH transmission.

In some examples, the UE 115-b may determine which report to transmit based on a priority of each report. For example, the network entity 105-a may configure a priority for each report (e.g., BSR, DSR, SDR, ESR) in cases when the UE 115-b may have more than one quantity to report. Such priorities may also be defined in a standards body. For example, when the correspondence 315 for the scheduling request 305 is associated with more than one report (e.g., BSR and ESR), the UE 115-b may use the priority to determine which report to transmit to the network entity 105-a. That is, if the candidate scheduling request values 325 correspond to reporting operations 320, where each reporting operation is transmission of a respective report, then the UE 115-b may transmit the scheduling request value 325 via the scheduling request 305 that corresponds to the highest priority report.

For example, if the UE 115-b does not have a data to report via the BSR, then the UE 115-b may report other quantities, such as a DSR, a SDR, or an ESR, based on the respective priorities of each report. In some examples, the BSR may be associated with the highest priority. In some other examples, the priority of the various reports may be based on a priority of each channel (LCH) or each LCG of the arrived data at the buffer of the UE 115-b, where, in such examples, the UE 115-b may determine the priority of each report. That is, the priority of each report may be based on L1 and L2 priorities, which may be defined in a standards body or configured by the network entity 105-a.

As an illustrative example, the network entity 105-a may transmit first control information 310 that includes the correspondence 315. The correspondence 315 may indicate that each candidate scheduling request value 325 corresponds to a respective reporting operation. For example, the scheduling request value 325-a may correspond to the operation 320-a, where the operation 320-a is to report the BSR. Likewise, the scheduling request value 325-b may correspond to the operation 320-b, where the operation 320-b is to report the ESR. In such examples, the UE 115-b may determine which report (e.g., BSR or ESR) to report based on priorities of the respective reports. As such, the UE 115-b may transmit the scheduling request value 325-a via the scheduling request 305 based on the BSR having a higher priority relative to that of the ESR. Alternatively, the UE 115-b may transmit the scheduling request value 325-b via the scheduling request 305 based on the ESR having a higher priority relative to that of the BSR. As described herein, the network entity 105-a may indicate such priorities to the UE 115-b, such priorities may be defined by a standards body, or both.

FIG. 4A, FIG. 4B, and FIG. 4C show examples of a wireless communications system 400, a wireless communications system 401, and a wireless communications system 402, respectively, that support scheduling request-indicated reporting enhancements in accordance with one or more aspects of the present disclosure. Aspects of the wireless communications system 400, the wireless communications system 401, and the wireless communications system 402 may implement, or be implemented by, aspects of the wireless communications system 100, the network architecture 200, and the wireless communications system 300 as described herein with reference to FIGS. 1 through 3. For example, the wireless communications system 400, the wireless communications system 401, and the wireless communications system 402 may each implement a UE 115-c and a network entity 105-b, which may be examples of corresponding devices described herein.

FIG. 4A. The techniques described in context of the wireless communications system 400 may enable the UE 115-c to indicate, via a scheduling request value 410 of a scheduling request 405, a format associated with a BSR 415, a table associated with the BSR 415, or a start index of the table associated with the BSR 415. For example, as described herein with reference to FIG. 3, the network entity 105-b may transmit first control information that indicates a correspondence between one or more candidate scheduling request values 410 (e.g., a value of ‘0’ or a value of ‘1’) and one or more operations that the UE 115-c is to perform.

In some examples, each of the one or more candidate scheduling request values 410 (e.g., a scheduling request value 410 of ‘0’ or a scheduling request value 410 of ‘1’) may correspond to respective formats of the table associated with the BSR 415 as detailed in table 3 below. Such formats may include a short BSR format, a short truncated BSR format, a long BSR format, or a long truncated BSR format, or various additional (e.g., enhanced formats).

TABLE 3

| | |
|---|---|
| Scheduling Request = ‘0’ | BSR with Format 0 |
| | (enhanced format) |
| Scheduling Request = ‘1’ | BSR with Format 1 |
| | (legacy format) |

In some examples, the one or more candidate scheduling request values 410 may correspond to a respective table associated with the BSR 415. For example, a first candidate scheduling request value 410 may be correspond to a table that is implemented for enhancements to the BSR 415 (e.g., a new table), may correspond to a legacy table associated with the BSR 415, or correspond to a reporting formats of the BSR 415. That is, the scheduling request value 410 may indicate whether a first table (e.g., table A) is used for the BSR 415 or a second table (e.g., table B) is used for the BSR 415 as detailed in table 4 below.

TABLE 4

| | |
|---|---|
| Scheduling Request = ‘0’ | Table A for BSR |
| Scheduling Request = ‘1’ | Table B for BSR |

In some examples, if the UE 115-c and the network entity 105-b implement a table for enhanced BSRs 415 (e.g., a larger table relative to the legacy table), then the candidate scheduling request values 410 may correspond to a respective start indices (e.g., entries) of a table associated with the BSR 415. As an illustrative example, a first scheduling request value 410 (e.g., value of ‘0’) may correspond to a first start index equal to a first quantity (e.g., Y), while a second scheduling request value 410 (e.g., value of ‘1’) may correspond to a second start index equal to a second quantity (e.g., X). In such examples, the first quantity and the second quantity may be dynamically configured by the network entity 105-b via the first control information. Further, in some examples, the scheduling request value 410 may indicate whether a lower part of the table is used or an upper part of the table is used as detailed in table 5 below.

TABLE 5

| | |
|---|---|
| Scheduling Request = ‘0’ | BSR with Enhanced Table Format |
| | (Lower Entries or Starting at Index Y) |
| Scheduling Request = ‘1’ | BSR with Enhanced Table Format |
| | (Upper Entries or Starting at Index X) |

As such, based on receiving the correspondence between the candidate scheduling request values 410 and the operations (e.g., various tables, formats, or starting indices), the UE 115-c may select one of the operations and indicate the selected operation via the scheduling request value 410. Based on transmitting the scheduling request 405, the UE 115-b may transmit the BSR 415 according to the table, the format, or the start index indicated by the UE 115-c via the scheduling request value 410. In this way, the UE 115-c and the network entity 105-b may reduce overhead signaling and improve coordination by leveraging a scheduling request value 410 of ‘0’ via the scheduling request 405.

FIG. 4B. The techniques described in the context of the wireless communications system 401 may enable the UE 115-c to indicate, via the scheduling request value 410, whether the UE 115-c is to report a first report type (e.g., DSR 420 or SDR) or a second report type (e.g., BSR 415). Because a scheduling request value 410 of ‘0’ is not used for the scheduling request 405, the UE 115-c and the network entity 105-b may use the scheduling request value 410 of ‘0’ in order to enhance signaling between the UE 115-c and the network entity 105-b. That is, the UE 115-c may transmit a variety of reports (e.g., such BSRs, DSRs, SDRs, ESRs, enhanced BSRs using tables, or the like). As such, the UE 115-c may use the additional codepoint of the value of ‘0’ via the scheduling request 405 in order to indicate whether the next BSR includes the BSR or the DSR 420.

For example, as described herein with reference to FIG. 3, the network entity 105-b may transmit first control information that indicates a correspondence between one or more candidate scheduling request values 410 (e.g., a value of ‘0’ or a value of ‘1’) of the scheduling request 405 and one or more operations that the UE 115-c is to perform. In some examples, each of the one or more candidate scheduling request values 410 may correspond to a respective report type that the UE 115-c is to transmit as detailed in table 6 below.

TABLE 6

| | |
|---|---|
| Scheduling Request = ‘0’ | Transmit the DSR |
| Scheduling Request = ‘1’ | Transmit the BSR |

As such, based on receiving the correspondence between the candidate scheduling request values 410 and the operations (e.g., report types), the UE 115-c may select one of the operations and indicate the selected operation via the scheduling request value 410. In some examples, the UE 115-c may select whether to report the DSR 420 or the BSR based on a priority of each report, whether the UE 115-c has data at the buffer of the UE 115-c, or both. As an illustrative example, if the UE 115-c indicates a scheduling request value 410 of ‘0’ via the scheduling request 405, then the UE 115-c may subsequently transmit the DSR 420 as a part of, or in place of, the BSR via MAC-CE signaling. In this way, the UE 115-b may indicate whether the UE 115-c is to report the DSR 420 or the BSR, thereby reducing signaling overhead and improving coordination between the devices.

FIG. 4C. The techniques described in the context of the wireless communications system 402 may enable the UE 115-c to indicate, via the scheduling request value 410, whether the UE 115-c is to report a first report type (e.g., ESR 425) or a second report type (e.g., BSR 415). For example, the UE 115-c may be an example of an EH device (e.g., such as a lower power device). As such, the UE 115-c and the network entity 105-c may leverage the unused codepoint of a scheduling request value 410 of ‘0’ in the scheduling request 405 in order to indicate that a BSR may be replaced with energy information or an energy request report via the ESR 425.

For example, as described herein with reference to FIG. 3, the network entity 105-b may transmit first control information that indicates a correspondence between one or more candidate scheduling request values 410 (e.g., a value of ‘0’ or a value of ‘1’) of the scheduling request 405 and one or more operations that the UE 115-c is to perform. In some examples, each of the one or more candidate scheduling request values 410 may correspond to a respective report type that the UE 115-c is to transmit as detailed in table 7 below.

TABLE 7

| | |
|---|---|
| Scheduling Request = ‘0’ | Transmit the ESR |
| Scheduling Request = ‘1’ | Transmit the BSR |

In some examples, the ESR 425 may be associated with a single LCG ID (e.g., virtual ID) at the UE 115-c or not associated with any LCG IDs at the UE 115-c. As such, if the ESR 425 is associated with a first LCG (e.g., virtual ID), then the UE 115-c may transmit the ESR 425 as a part of a BSR, where the portion of the BSR associated with the first LCG may include the ESR 425. That is, the UE 115-c may use the LCG ID byte and one or more LCG BSR bytes in order to indicate one or more elements of the ESR 425 as detailed below in table 8.

TABLE 8

| | |
|---|---|
| Scheduling | Transmit the BSR with some |
| Request = ‘0’ | LCGs replaced with the ESR |
| | 425 (e.g., LCGs associated with |
| | ESR 425 may be used for ESR |
| | 425 if the LCGs do not have data |
| | to report in a BSR) |
| Scheduling | Transmit the BSR |
| Request = ‘1’ | |

Alternatively, if the ESR 425 is not associated with a LCG, then the UE 115-c may use the scheduling request value 410 of ‘0’ to indicate that a subsequent MAC-CE signal will include the ESR 425 as detailed in table 9 below. In such examples, the UE 115-c may transmit a single-entry MAC-CE with eight bits, where the eight bits correspond to the ESR 425, in accordance with the indication.

TABLE 9

| | |
|---|---|
| Scheduling Request = ‘0’ | Transmit the ESR via |
| | 8 Bits of MAC-CE |
| Scheduling Request = ‘1’ | Transmit the BSR |

FIG. 5 shows an example of a wireless communications system 500 that supports scheduling request-indicated reporting enhancements in accordance with one or more aspects of the present disclosure. Aspects of the wireless communications system 500 may implement, or be implemented by, aspects of the wireless communications system 100, the network architecture 200, the wireless communications system 300, the wireless communications system 400, the wireless communications system 401, and the wireless communications system 402 as described herein with reference to FIGS. 1 through 4C. The wireless communications system 500 may include a network entity 105-c and a UE 115-d, which may be examples of corresponding devices described herein. The techniques described in the context of the wireless communications system 500 may enable the UE 115-d and the network entity 105-d to indicate one or more operations 520 via a scheduling request value 525 of a scheduling request 510 and a BSR value 530 of a BSR 515.

In some examples, in addition to using a scheduling request value 525 of ‘0’ for the scheduling request 510 (e.g., which may be used to indicate one or more operations, such as reports or information), the UE 115-d and the network entity 105-c may leverage two additional codepoints for associated with a scheduling request value 525 of ‘1’ for the scheduling request 510 for other purposes.

For example, the UE 115-d may leverage a codepoint with the scheduling request value 525 of ‘1’ for the scheduling request 510 (e.g., scheduling request 510 equals ‘1’) and a BSR value 530 of ‘0’ for the BSR 515 (e.g., the BSR 515 equals ‘0’), where such a codepoint by the UE 115-d may be invalid. For example, such a codepoint may signify that the UE 115-d has data to transmit (e.g., scheduling request value 525=‘1’), but the UE 115-d has zero bits to transmit (e.g., BSR value 530=‘0’), as such this codepoint may be invalid in the current designs. As such, the UE 115-d and the network entity 105-c may use this codepoint (e.g., scheduling request value 525=‘1’ and BSR value 530=‘0’) in order to indicate one or more operations 520. Similarly, the UE 115-d and the network entity 105-c may leverage a codepoint with the scheduling request value 525 of ‘1’ and a BSR value 530 of ‘255,’ which may be a reserved entry in the BSR 515 in order to indicate various operations 520.

By leveraging the four different unused codepoints of the scheduling request value 525 and the BSR value 530 (e.g., scheduling request value 525=‘0’ or ‘1’ and BSR value 530=‘0’ or ‘255’), the UE 115-d and the network entity 105-c may be able to implement additional reporting (e.g., DSR, ESR, or the like) in the wireless communications system 500. The UE 115-d may implement such codepoints based on an L1 indication from the network entity 105-c or based on one or more conditions, such as all LCGs of the UE 115-d have no data or the UE 115-d does not have a BSR to report.

For example, the network entity 105-c may transmit first control information 505 that includes a correspondence 535 (e.g., a mapping) between one or more operations 520 and a combination of candidate scheduling request values 525 of the scheduling request 510 and BSR values 530 of the BSR 515. As an illustrative example, the correspondence 535 may indicate a mapping between an operation 520-a and a combination of a scheduling request value 525-a and BSR value 530-a. Similarly, the correspondence 535 may indicate a mapping between the operation 520-b and a combination of the scheduling request value 525-b and the BSR value 530-b. The correspondence 535 may include mappings for up to four operations 520 and four combinations of the scheduling request values 525 and the BSR values 530.

In some examples, the combination of the scheduling request values 525 and the BSR values 530 may correspond to one or more operations 520 associated with different DSRs as detailed in tables 10 and 11.

TABLE 10

| | |
|---|---|
| Scheduling Request = ‘0’ | DSR 1 |
| Scheduling Request = ‘0’ | DSR 2 |
| and BSR = ‘0’ | |
| Scheduling Request = ‘0’ | DSR 3 |
| and BSR = ‘255’ | |

TABLE 11

| | |
|---|---|
| Scheduling Request = ‘0’ and BSR = ‘0’ | DSR 1 |
| Scheduling Request = ‘0’ and BSR = ‘255’ | DSR 2 |
| Scheduling Request = ‘1’ and BSR = ‘0’ | DSR 3 |
| Scheduling Request = ‘1’ and BSR = ‘255’ | DSR 4 |

In such examples, each DSR (e.g., DSR 1, DSR 2, DSR 3, DSR 4) of the different DSRs may be associated with a respective look-up table, such that the network entity 105-c may identify the DSR of the UE 115-d based on the combination of the scheduling request value 525 and the BSR value 530 as detailed in table 12.

TABLE 12

| | |
|---|---|
| DSR 1 (e.g., SDR) | Average or variance of Twait or |
| | remaining PDB is below X1 |
| DSR 2 (e.g., SDR) | Average or variance of Twait or |
| | remaining PDB is between X1 and X2 |
| DSR 3 | Average or variance of Twait or |
| | remaining PDB is between X2 and X3 |
| DSR 4 | Average or variance of Twait or |
| | remaining PDB is above X3 |

Such thresholds (e.g., X1, X2, and X3) may be defined by a standard or be configured by the network entity 105-c. As an illustrative example, the UE 115-d may determine that the average wait time (e.g., Twait) of an uplink packet at the buffer of the UE 115-d is between a first threshold (e.g., X1) and a second threshold (e.g., X2). As such, the UE 115-d may transmit the scheduling request 510 with the scheduling request value 525 and the BSR 515 with the BSR value 530, such that the combination of the scheduling request value 525 and the BSR value 530 indicate DSR 2. In this way, the UE 115-d and the network entity 105-c may experience a reduction in overhead for DSRs.

In some other examples, the combination of the scheduling request values 525 and the BSR values 530 may correspond to one or more operations 520 associated with different ESRs as detailed in tables 13 and 14.

TABLE 13

| | |
|---|---|
| Scheduling Request = ‘0’ | ESR 1 (energy information |
| | or energy request report 1) |
| Scheduling Request = ‘1’ and | ESR 2 (energy information |
| BSR = ‘0’ | or energy request report 2) |
| Scheduling Request = ‘0’ and | ESR 3 (energy information |
| BSR = ‘255’ | or energy request report 3) |

TABLE 14

| | |
|---|---|
| Scheduling Request = ‘0’ and | ESR 1 (energy information |
| BSR = ‘0’ | or energy request report 1) |
| Scheduling Request = ‘0’ and | ESR 2 (energy information |
| BSR = ‘255’ | or energy request report 2) |
| Scheduling Request = ‘1’ and | ESR 3 (energy information |
| BSR = ‘0’ | or energy request report 3) |
| Scheduling Request = ‘1’ and | ESR 4 (energy information |
| BSR = ‘255’ | or energy request report 4) |

In such examples, each ESR (e.g., ESR 1, ESR 2, ESR 3, ESR 4) of the different DSRs may be associated with a respective look-up table, such that the network entity 105-c may identify the ESR of the UE 115-d based on the combination of the scheduling request value 525 and the BSR value 530. In some other examples, the combination of the scheduling request values 525 and the BSR values 530 may correspond to one or more operations 520 associated with energy state information as detailed in tables 15, 16, 17, 18, and 19.

TABLE 15

| | |
|---|---|
| Scheduling Request = | Charging Rate is greater than a threshold; |
| ‘0’ and BSR = ‘0’ | Network entity to keep sending energy for |
| | charging at the UE; |
| | If charging rate is from an entity other than |
| | the network entity (e.g., bands or tech), |
| | indication that the UE has a charging rate |
| | above a threshold; |
| | UE has enough energy or charge for |
| | communications for at least one of a |
| | receive signals (e.g., receive at least one |
| | or more of data and reference signals), |
| | transmit signal, or both |
| Scheduling Request = | Charging Rate is lower than a threshold |
| ‘0’ and BSR = ‘255’ | |
| Scheduling Request = | Charging Request of X energy units; or |
| ‘1’ and BSR = ‘0’ | request for an EH duration; or request for |
| | an EH profile |
| Scheduling Request = | Charging Request of Y energy units; or |
| ‘1’ and BSR = ‘255’ | request for an EH duration |

TABLE 16

| | |
|---|---|
| Scheduling Request = ‘0’ and | Charging Rate is between |
| BSR = ‘0’ | Threshold 1 and Threshold 2 |
| Scheduling Request = ‘0’ and | Charging Rate is between |
| BSR = ‘255’ | Threshold 2 and Threshold 3 |
| Scheduling Request = ‘1’ and | Charging Rate is above |
| BSR = ‘0’ | Threshold 3 |
| Scheduling Request = ‘1’ and | Charging Rate is below |
| BSR = ‘255’ | Threshold 1 |

TABLE 17

| | |
|---|---|
| Scheduling Request = ‘0’ and | UE to enter EH cycle with |
| BSR = ‘0’ | a duration of X1 |
| Scheduling Request = ‘0’ and | UE to enter EH cycle with |
| BSR = ‘255’ | a duration of X2 |
| Scheduling Request = ‘1’ and | UE to enter EH cycle with |
| BSR = ‘0’ | a duration of X3 |
| Scheduling Request = ‘1’ and | UE to enter EH cycle with |
| BSR = ‘255’ | a duration of X4 |

TABLE 18

| | |
|---|---|
| Scheduling Request = | Request for an EH-to-data cycle, a |
| ‘0’ and BSR = ‘0’ | discontinuous reception (DRX), a |
| | discontinuous transmission (DTX) |
| | cycle, or combination thereof with |
| | a first configuration. |
| Scheduling Request = | Request for an EH-to-data cylce, |
| ‘0’ and BSR = ‘255’ | a DRX cycle, a DTX cycle, or |
| | combination thereof with a second |
| | configuration |
| Scheduling Request = | Request for an EH-to-data cycle, |
| ‘1’ and BSR = ‘0’ | a DRX cycle, a DTX cycle, or |
| | combination thereof with a third |
| | configuration |
| Scheduling Request = | Request for an EH-to-data cycle, |
| ‘1’ and BSR = ‘255’ | a DRX cycle, a DTX cycle, or |
| | combination thereof with a fourth |
| | configuration |

TABLE 19

| | |
|---|---|
| Scheduling Request = | UE is operating in Communication State |
| ‘0’ and BSR = ‘0’ | or Energy State X (e.g., X may be the ID of |
| | the energy or communication state) |
| Scheduling Request = | UE is operating in Communication State |
| ‘0’ and BSR = ‘255’ | or Energy State Y (e.g., Y may be the ID of |
| | the energy or communication state) |
| Scheduling Request = | UE is operating in Communication State |
| ‘1’ and BSR = ‘0’ | or Energy State Z (e.g., Z may be the ID of |
| | the energy or communication state) |
| Scheduling Request = | UE is operating in Communication State |
| ‘1’ and BSR = ‘255’ | or Energy State L (e.g., L may be the ID of |
| | the energy or communication state) |

Such thresholds, configurations, durations, or the like, may be defined by a standard or be configured by the network entity 105-c. As an illustrative example, the UE 115-d may determine that a charging rate of the UE 115-d satisfies a first threshold. As such, the UE 115-d may transmit the scheduling request 510 with the scheduling request value 525 and the BSR 515 with the BSR value 530, such that the combination of the scheduling request value 525 and the BSR value 530 indicate that the charging rate of the UE 115-d satisfies the threshold. In this way, the UE 115-d and the network entity 105-c may experience a reduction in overhead for ESRs.

In some other examples, the combination of the scheduling request values 525 and the BSR values 530 may correspond to one or more operations 520 associated with different reporting procedures as detailed in table 20.

TABLE 20

| | |
|---|---|
| Scheduling Request = | ESR or DSR Procedure |
| ‘0’ and BSR = ‘X’ | |
| Scheduling Request = | BSR Procedure |
| ‘1’ and BSR = ‘X’ | |

In such examples, ‘X’ may represent any BSR value 530. Further, in such examples, if the scheduling request value 525 is ‘1’ and the BSR value 530 is ‘0’ or ‘255,’ then the UE 115-d may use such values as additional codepoints to indicate an ESR procedure, DSR procedure, SDR procedure, or communication state as described herein. Alternatively, if the scheduling request value 525 is ‘1,’ then regardless of the BSR value 530, the scheduling request value 525 may indicate a BSR procedure.

In some examples, the combination of the scheduling request values 525 and the BSR values 530 may correspond to one or more operations 520 associated with SSSG switching as detailed in table 21.

TABLE 21

| | |
|---|---|
| Scheduling Request = | UE is to operate in SSSG 0; |
| ‘0’ and BSR = ‘0’ | If UE is currently operating in SSSG 0, |
| | then this codepoint may indicate this is |
| | to perform a PDCCH skipping procedure. |
| | If UE is currently performing the PDCCH |
| | skipping procedure, then this codepoint |
| | may indicate the is to continue performing |
| | the PDCCH skipping procedure, cancel |
| | the PDCCH skipping procedure, or extend |
| | duration or interval of the PDCCH skipping |
| | procedure. |
| Scheduling Request = | UE is to operate in SSSG 1 |
| ‘0’ and BSR = ‘255’ | |
| Scheduling Request = | UE is to operate in SSSG 2 |
| ‘1’ and BSR = ‘0’ | |
| Scheduling Request = | UE is to operate in SSSG 3 |
| ‘1’ and BSR = ‘255’ | |

In some examples, the combination of the scheduling request values 525 and the BSR values 530 may correspond to one or more operations 520 associated with a PDCCH skipping procedure as detailed in tables 22 and 23.

TABLE 22

| | |
|---|---|
| Scheduling Request = | Cancel PDCCH Skipping Procedure |
| ‘0’ and BSR = ‘X’ | |
| Scheduling Request = | Maintain PDCCH Skipping Procedure; |
| ‘1’ and BSR = ‘X’ | or Reduce PDCCH Skipping Duration |

TABLE 23

| | |
|---|---|
| Scheduling Request = | PDCCH Skipping for a Duration of X |
| ‘0’ and BSR = ‘0’ | |
| Scheduling Request = | PDCCH Skipping for a Duration of Y |
| ‘0’ and BSR = ‘255’ | |
| Scheduling Request = | PDCCH Skipping for a Duration of Z |
| ‘1’ and BSR = ‘0’ | |
| Scheduling Request = | PDCCH Skipping for a Duration of L |
| ‘1’ and BSR = ‘255’ | |

In the example of table 23, the values of X, Y, Z, and L (e.g., the durations) may be based on whether the UE 115-d is currently performing the PDCCH skipping procedure (e.g., operating according to a skipping duration), based on an energy state of the UE 115-d, or based on a communication state of the UE 115-d. For example, if the UE 115-d is operating according to a skipping duration (e.g., operating in a PDCCH skipping procedure), then the UE 115-d may indicate one of the values of X, Y, Z, or L. Alternatively, if the UE 115-d is not operating according to a skipping duration (e.g., is not currently performing PDCCH skipping), then the UE 115-d may indicate different durations, such as X2, Y2, Z2, or L2.

Further, the UE 115-d may indicate various operations based on the value of the duration parameters (e.g., X, Y, Z, and L). As an illustrative example, if the UE 115-d is currently performing the PDCCH skipping procedure and indicates, via the combination of the scheduling request value 525 and the BSR value 530, that X is equal to zero, then the UE 115-d may indicate to the network entity 105-c to cancel PDCCH skipping (e.g., cancel control signaling skipping). Alternatively, if the UE 115-d indicates, via the combination of the scheduling request value 525 and the BSR value 530, that X is equal to zero while the UE 115-d is currently not performing the PDCCH skipping procedure, then the UE 115-d may indicate that the UE 115-d does not recommend the PDCCH skipping procedure. Such techniques may also be used to indicate various communication or energy state indications as detailed in tables 24 and 25.

TABLE 24

| Scheduling | PDCCH Skipping for a duration of X; |
|---|---|
| request = ‘0’ | or Cancellation of PDCCH Skipping Procedure; |
| | or Switch to SSSG 0 (e.g., default SSSG); or |
| | Switch to a default communication state; or |
| | Switch to a default energy state. |
| Scheduling | PDCCH Skipping for a duration of Z; or |
| request = ‘1’ | Switch to a first SSSG state; or |
| and BSR = | Switch to a first communication state; or |
| ‘0’ | Switch to a first energy state. |
| Scheduling | PDCCH Skipping for a duration of L; or |
| request = ‘1’ | Switch to a second SSSG state; or |
| and BSR = | Switch to a second communication state; or |
| ‘255’ | Switch to a second energy state. |

TABLE 25

| | |
|---|---|
| Scheduling request = | Indication for a second stage related to: |
| ‘0’ and BSR = ‘X’ | PDCCH skipping procedure; or |
| | SSSG switching procedure; or |
| | communication state switching procedure; or |
| | continue to operate in the communication state. |
| Scheduling request = | BSR procedure |
| ‘1’ and BSR = ‘X’ | |

In the example of table 25, the scheduling request value 525 of ‘0’ may be a first stage indication for a second stage MAC-CE as described herein with reference to FIG. 3. That is, if the scheduling request value 525 is ‘1’ and the BSR value 530 is ‘0’ or ‘255,’ then the UE 115-d may use such values as additional codepoints to indicate a second state related to at least one of a PDCCH skipping procedure, a SSSG switching procedure, a communication state switching procedure, or an indication to continue to operate in the current communication state as described herein. Alternatively, if the scheduling request value 525 is ‘1,’ then regardless of the BSR value 530, the scheduling request value 525 may indicate a BSR procedure.

Based on transmitting the scheduling request value 525 via the scheduling request 510 and the BSR value 530 via the BSR 515, the UE 115-d may perform the operation indicated by the combination of such values. In this way, the UE 115-d and the network entity 105-c may leverage four unused codepoints in order for the UE 115-d to indicate an operation 520 to perform in accordance with the correspondence 535, thereby reducing signaling overhead and increasing coordination between devices.

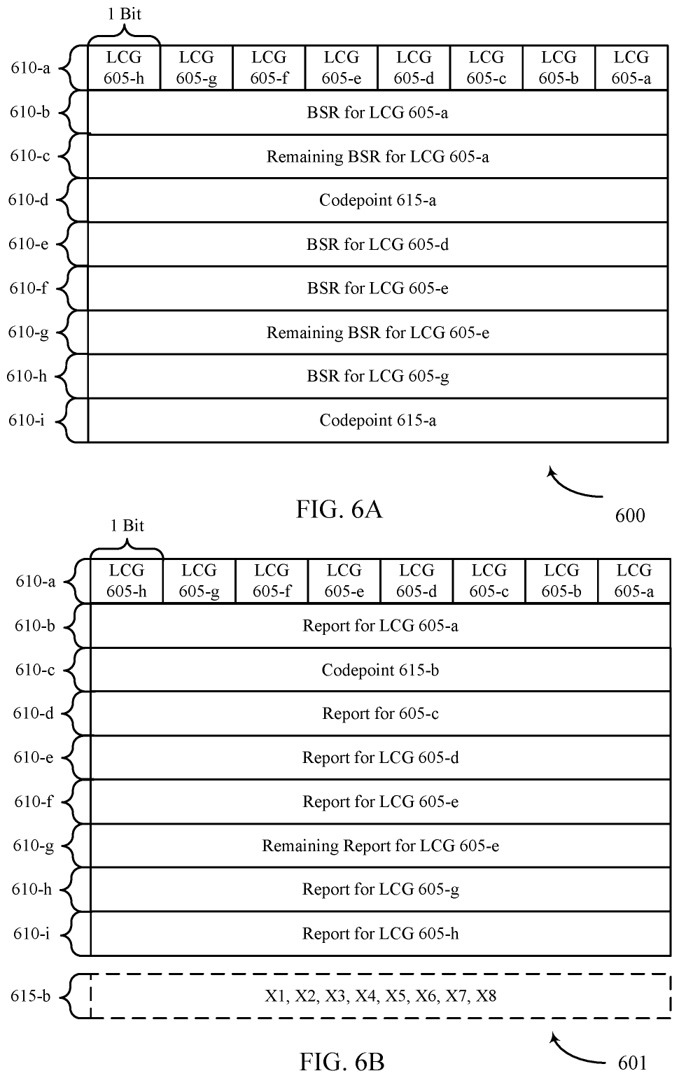

FIG. 6A and FIG. 6B show examples of a BSR 600 and a BSR 601, respectively, that support scheduling request-indicated reporting enhancements in accordance with one or more aspects of the present disclosure. Aspects of the BSR 600 and the BSR 601 may be implemented by aspects of the wireless communications system 100, the network architecture 200, the wireless communications system 300, the wireless communications system 400, the wireless communications system 401, the wireless communications system 402, and the wireless communications system 500 as described herein with reference to FIGS. 1 through 5. For example, the BSR 600 and the BSR 601 may be communicated by a UE 115 to a network entity 105, which may be examples of corresponding devices described herein.

FIG. 6A. The techniques described in the context of the BSR 600 may enable the UE 115 to transmit additional bits for BSRs for one or more LCGs 605 via one or more unused portions of the BSR 600. For example, the BSR 600 may include a byte 610-a (e.g., otherwise known as the header of the BSR 600), where the byte 610-a may include eight bits. Each bit of the byte 610 may be associated with a respective LCG 605. For example, the least significant bit in the first byte of the BSR 600 may be associated with the LCG 605-a, while the most significant bit in the first byte of the BSR 600 may be associated with the LCG 605-h.

Further, the subsequent bytes 610 may be allocated for BSR information associated with each LCG 605. For example, byte 610-b may be allocated for BSR information associated with the LCG 605-a, byte 610-c may be allocated for BSR information associated with LCG 605-b, byte 610-d may be allocated for BSR information associated with LCG 605-c, byte 610-e may be allocated for BSR information associated with LCG 605-d, byte 610-f may be allocated for BSR information associated with LCG 605-c, byte 610-g may be allocated for BSR information associated with LCG 605-f, byte 610-h may be allocated for BSR information associated with LCG 605-g, and byte 610-i may be allocated for BSR information associated with the LCG 605-h. In this way, the UE 115 may transmit the BSR 600 that includes BSR information for each LCG 605.

In accordance with the techniques described herein, the UE 115 may transmit additional bits of BSR information for various LCGs (e.g., use 16 bit tables instead of 8 bits for some LCGs 605) via one or more unused portions (e.g., unused bytes 610 that correspond to unused LCGs 605) of the BSR 600.

For example, the network entity 105 may configure the UE 115 with a scheduling request occasion, where the scheduling request occasion is associated with a reduced quantity of LCGs 605 (e.g., less than eight LCG 605 IDs). In such examples, the network entity 105 may reduce the quantity of LCGs 605 associated with the scheduling request occasion up to a threshold quantity, in order to reduce the quantity of blind decodes at the network entity 105. As such, because the UE 115 is to report BSR information for a reduced quantity of LCGs 605 via the BSR 600, the UE 115 may use additional bytes 610 (e.g., for example 2 bytes 610) for the BSR information for LCGs 605 via the BSR 600. In such examples, the BSR 600 may be referred to as a long BSR format. In order to leverage the unused portions of the BSR 600 (e.g., reduced quantity of LCGs 605), the UE 115 may use the unused portions of the BSR in cases that the remaining LCGs 605 of the UE 115 have BSR information report.

For example, the UE 115 may include a ‘0’ in each bit associated with the LCGs 605 in order to indicate that the byte 610 associated with the LCG 605 is unused. In this way, the UE 115 may transmit an extended (e.g., longer) BSR format for one or more LCGs 605 in cases when one or more bytes 610 associated with LCGs 605 are unused. In such examples, the network entity 105 may group the LCGs 605 in order to share the pool of bits and indicate such groupings to the UE 115. As such, when one LCG 605 is not used, then the UE 115 may be able to use the unused portion of the BSR 600 for BSR information of the remaining LCGs 605 based on a priority of the remaining LCGs 605.

As an illustrative example, the UE 115 may receive an indication that the LCG 605-a, the LCG 605-b, and the LCG 605-c are grouped. In such examples, the LCG 605-a may have a higher priority than the LCG 605-b and the LCG 605-c, and the LCG 605-b may have a higher priority than the LCG 605-c. As such, if the UE 115 does not have BSR information for the LCG 605-b, then the UE 115 may reuse the byte 610-c corresponding to the LCG 605-b for additional, or remaining, BSR information for LCG 605-a. Further, if the UE 115 determines that both the LCG 605-b and the LCG 605-c have empty BSRs, then the UE 115 may use both the byte 610-c and the byte 610-d for BSR information for the LCG 605-a. In order to indicate such information to the network entity 105, the UE 115 may set the bit corresponding to the LCG 605-b to ‘0’, thereby indicating to the network entity 105 that the byte 610-c may be an unused portion. As such, based on the priority information, the network entity 105 may determine that the information in the unused byte 610-c may be associated with the LCG 605-a.

In some examples, the UE 115 may jointly encode the LCGs 605 (e.g., and corresponding IDs), such that a single codepoint may represent when a byte 610 associated with an LCG 605 is not used. In such examples, the remaining values of the BSR 600 may be used to represent a higher resolution BSR 600 from one or more tables (e.g., which may be larger). Further, in some examples, some bits of the BSR 600 may be used to indicate a table type, if not indicated via the scheduling request. Alternatively, such bits may be jointly indicated in the scheduling request associated with the BSR 600 and via one or more bits from the byte 610-a associated with the LCGs 605.

In some examples, the UE 115 may use a codepoint 615-a (e.g., such as 0010000) in order to indicate whether the BSR information of an LCG 605 grouped with another LCG 605 is extended or not. Such a codepoint 615-a may be configured by the network entity via L1, L2, or L3 signaling or defined in a standards body. Additionally, the codepoint 615-a may be used to indicate various formats or types of reports, as further described herein with reference to FIG. 6B. As an illustrative example, if the LCG 605-a, the LCG 605-b, and the LCG 605-c are grouped together and both the LCG 605-b and the LCG 605-c are unused, then the UE 115 may use the byte 610-c to extend the BSR information for the LCG 605-a. However, if the UE 115 does not have BSR information to extend into the byte 610-d associated with the LCG 605-c, then the UE 115 may include the codepoint 615-a in order to indicate that the UE 115 has not extended the BSR information for LCG 605-a into the byte 610-d.

FIG. 6B. The techniques described in the context of the BSR 601 may enable the UE 115 to transmit various reports (e.g., ESRs, DSRs, or SDRs) for one or more LCGs 605 via one or more unused portions of the BSR 601. For example, the BSR 601 may include a byte 610-a (e.g., otherwise known as the header of the BSR 601), where the byte 610-a may include eight bits. Each bit of the byte 610 may be associated with a respective LCG 605. For example, the least significant bit (LSB or the first bit of a sequence of bits) in the first byte of the BSR 601 may be associated with the LCG 605-a, while the most significant bit in the first byte of the BSR 601 may be associated with the LCG 605-h.

Further, the subsequent bytes 610 may be allocated for BSR information associated with each LCG 605. For example, byte 610-b may be allocated for BSR information associated with the LCG 605-a, byte 610-c may be allocated for BSR information associated with LCG 605-b, byte 610-d may be allocated for BSR information associated with LCG 605-c, byte 610-e may be allocated for BSR information associated with LCG 605-d, byte 610-f may be allocated for BSR information associated with LCG 605-e, byte 610-g may be allocated for BSR information associated with LCG 605-f, byte 610-h may be allocated for BSR information associated with LCG 605-g, and byte 610-i may be allocated for BSR information associated with the LCG 605-h. In this way, the UE 115 may transmit the BSR 601 that includes BSR information for each LCG 605.

In accordance with the techniques described herein, the UE 115 may transmit ESRs, DSRs, or SDRs for one or more LCGs 605 via unused portions of the BSR 601. Alternatively, the UE 115 may transmit a DSR for a single LCG 605 across all or several unused portions of the BSR 601 in accordance with L1, L2, or L3 signaling from the network entity 105.

For example, the network entity 105 may transmit an indication of the codepoint 615-b to the UE 115, such that the UE 115 may use the codepoint 615-b to indicate a table, a report type, or a report format associated with the information for the remaining LCGs 605. As such, the UE 115 may include, via the first unused portion of the BSR 601, the codepoint 615-b (e.g., BSR bits) in order to indicate the table, the report type, or the report format for each LCG 605 in the BSR 601. As an illustrative example, if the UE 115 does not have BSR information for the LCG 605-b, then the UE 115 may set the bit corresponding to the LCG 605-b in the byte 610-a to a ‘0’ and include the codepoint 615-b (e.g., such as X1, X2, X3, X4, X5, X6, X7, X8).

In some examples, the UE 115 may use a first portion of the bits of the codepoint 615-b (e.g., X1 X2) to indicate the table format or the report type associated with each LCG 605. In such examples, the UE 115 may use the remaining portion of the bits (e.g., X3, X4, X5, X6, X7, X8) in order to indicate a point in a codebook of the network entity 105 (in addition to the other bits of the bytes 610). In some other examples, a portion of the codepoint 615-b may be used for remaining bits for a report (e.g., BSR, DSR, or ESR) of an associated LCG 605, while the remaining portion of the codepoint 615-b may be used to indicate the report type, report format, or table associated with the information for the remaining LCGs 605.

As an illustrative example, the UE 115 may include the include the codepoint 615-b in the byte 610-c, where the codepoint 615-b indicates that the remaining bytes 610 of the BSR 601 include respective DSRs for each LCG 605 (e.g., excluding the LCG 605-b). The UE 115 may also set the bit associated with the LCG 605-b of the byte 610-a to ‘0’, such that the network entity 105 may have an indication that the byte 610-c is an unused portion. As such, the UE 115 may transmit a respective DSR as a part of the bytes 610 for each LCG 605 via the BSR 601 according to the codepoint 615-b. In such examples, the network entity 105 may identify the unused portion of the BSR 601 based on the bit associated with the LCG 605-b of the byte 610-a and identify the codepoint 615-b.

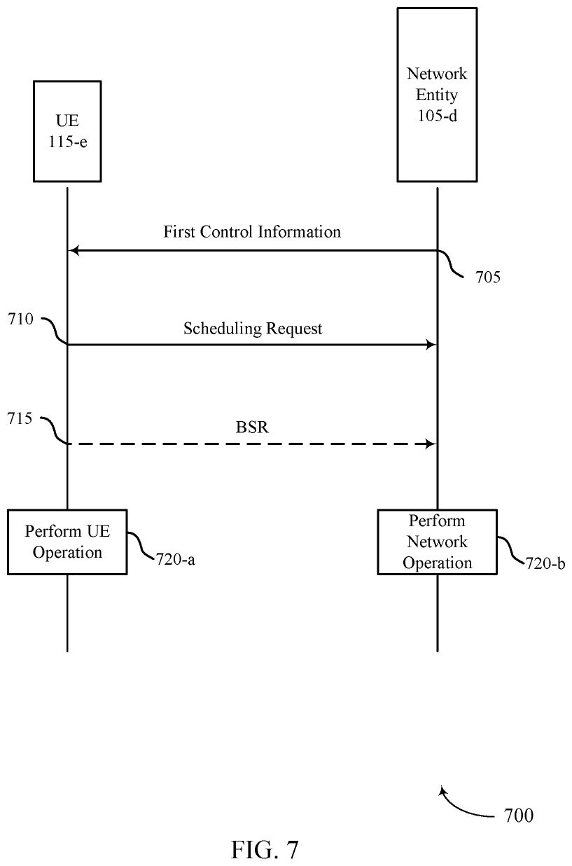

FIG. 7 shows an example of a process flow 700 that supports scheduling request-indicated reporting enhancements in accordance with one or more aspects of the present disclosure. Aspects of the process flow 700 may implement, or be implemented by, aspects of the wireless communications system 100, the network architecture 200, the wireless communications system 300, the wireless communications system 400, the wireless communications system 401, the wireless communications system 402, the wireless communications system 500, the BSR 600, and the BSR 601 as described herein with reference to FIGS. 1 through 6B. For example, the process flow 700 may include a UE 115 or a network entity 105, which may be examples of corresponding devices described herein.

At 705, the UE 115-e may receive first control information indicative of a correspondence between one or more operations at the UE 115-e and at least one or more candidate values of a scheduling request as described herein with reference to FIG. 3. In some examples, the correspondence may be further between a combination of the one or more candidate values of the scheduling request and a value of a BSR as described herein with reference to FIG. 5. In such examples, one of the one or more candidate values may be a logical ‘0.’ In some examples, the size of the one or more candidate values of the scheduling request may be at least two bits of information.

In some examples, the one or more operations may include reporting operations (e.g., transmission of a BSR, a DSR, an ESR, a SDR), PDCCH skipping operations, SSSG switching operations, communication state switching operations, first and second stage indication operations, or a combination thereof as described herein with reference to FIGS. 3 through 5. In some examples, the first control information may indicate that the scheduling request is associated with a reduced quantity of LCGs as described herein with reference to FIG. 6.

At 710, the UE 115-e may transmit the scheduling request in accordance with the first control information, where a value of the scheduling request is indicative, at least in part, of a UE operation of the one or more operations. At 715, in some examples, the UE 115-e may transmit the BSR, where a combination between the value of the scheduling request and the value of the BSR is indicative of the UE operation of the one or more operations as described herein with reference to FIG. 5.

At 720-a and 720-b, the UE 115-e and the network entity 105-d may perform the UE operation and the network operation, respectively, in accordance with the value of the scheduling request or the combination of the value of the scheduling request and the value of the BSR.

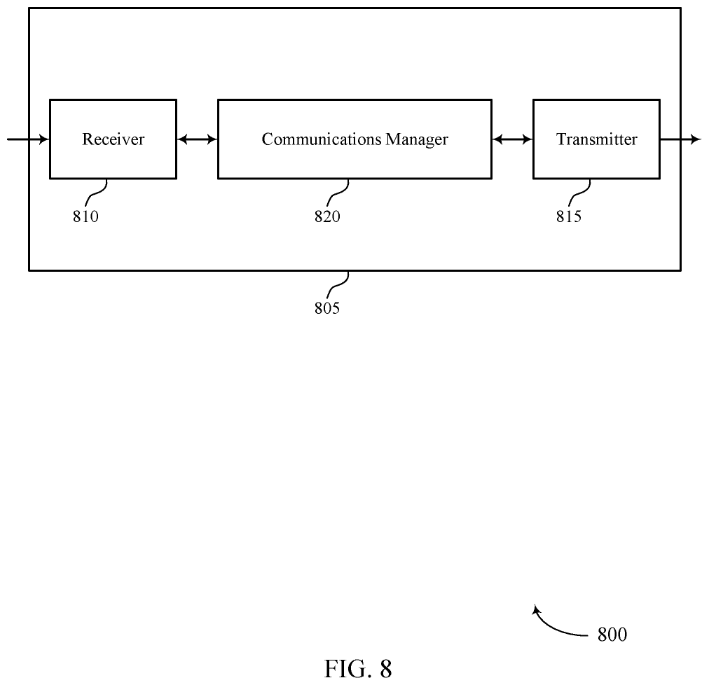

FIG. 8 shows a block diagram 800 of a device 805 that supports scheduling request-indicated reporting enhancements in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to scheduling request-indicated reporting enhancements). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to scheduling request-indicated reporting enhancements). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of scheduling request-indicated reporting enhancements as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 is capable of, configured to, or operable to support a means for receiving first control information indicative of a correspondence between one or more operations at the UE and at least one or more candidate values of a scheduling request. The communications manager 820 is capable of, configured to, or operable to support a means for transmitting the scheduling request in accordance with the first control information, a value of the scheduling request indicative, at least in part, of a UE operation of the one or more operations. The communications manager 820 is capable of, configured to, or operable to support a means for performing the UE operation in accordance with the value of the scheduling request.

The communications manager 820 may be an example of means for performing various aspects of scheduling request-indicated reporting enhancements as described herein. The communications manager 820, or its sub-components, may be implemented in hardware (e.g., in communications management circuitry). The circuitry may comprise of processor, DSP, an ASIC, a FPGA, or other programmable logic device, discrete gate or transistor logic, discrete hardware components, or any combination thereof designed to perform the functions described in the present disclosure.

In another implementation, the communications manager 820, or its sub-components, may be implemented in code (e.g., as communications management software or firmware) executed by a processor, or any combination thereof. If implemented in code executed by a processor, the functions of the communications manager 820, or its sub-components may be executed by a general-purpose processor, a DSP, an ASIC, a FPGA, or other programmable logic device.

In some examples, the communication manager 820 may be configured to perform various operations (e.g., receiving and transmitting) using or otherwise in cooperation with the receiver 810, the transmitter 815, or both.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for indicating one or more UE operations via a value (e.g., zero) of a scheduling request, thereby resulting in more efficient utilization of communication resources.

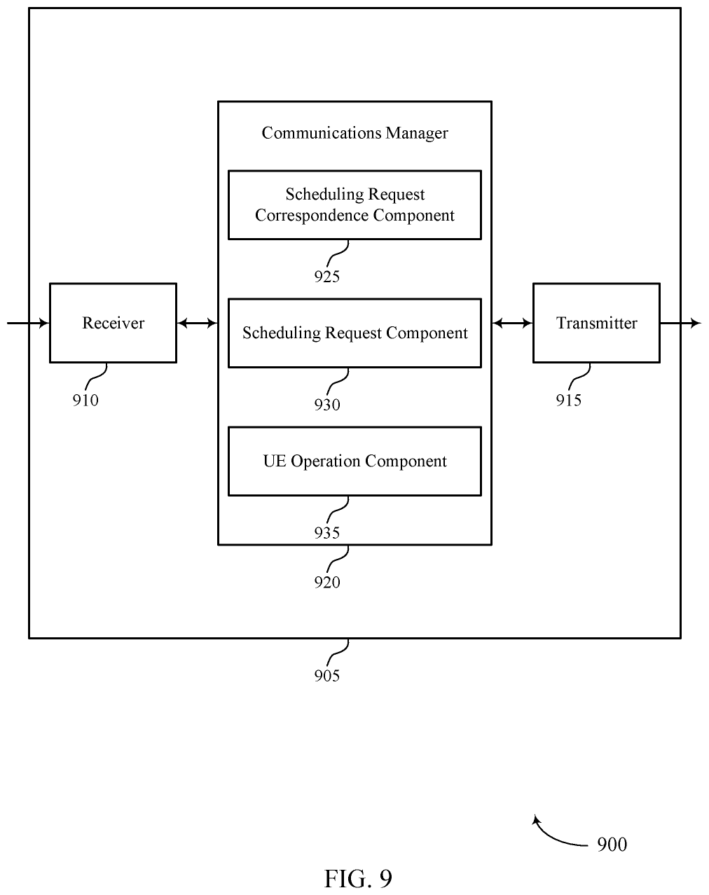

FIG. 9 shows a block diagram 900 of a device 905 that supports scheduling request-indicated reporting enhancements in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to scheduling request-indicated reporting enhancements). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to scheduling request-indicated reporting enhancements). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of scheduling request-indicated reporting enhancements as described herein. For example, the communications manager 920 may include a scheduling request correspondence component 925, a scheduling request component 930, a UE operation component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The scheduling request correspondence component 925 is capable of, configured to, or operable to support a means for receiving first control information indicative of a correspondence between one or more operations at the UE and at least one or more candidate values of a scheduling request. The scheduling request component 930 is capable of, configured to, or operable to support a means for transmitting the scheduling request in accordance with the first control information, a value of the scheduling request indicative, at least in part, of a UE operation of the one or more operations. The UE operation component 935 is capable of, configured to, or operable to support a means for performing the UE operation in accordance with the value of the scheduling request.

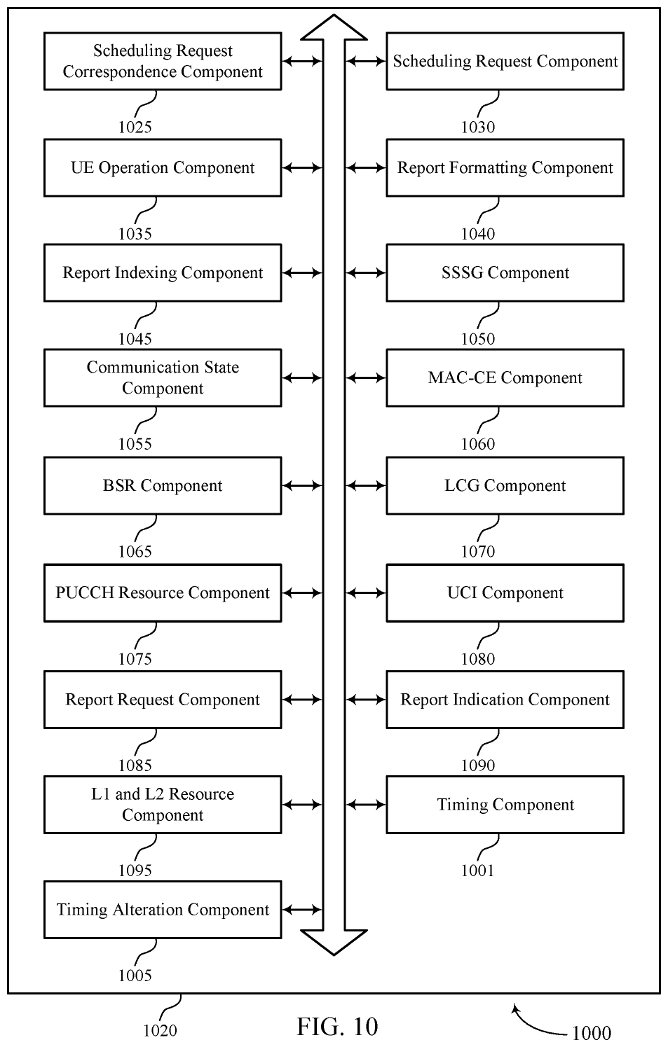

FIG. 10 shows a block diagram 1000 of a communications manager 1020 that supports scheduling request-indicated reporting enhancements in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of scheduling request-indicated reporting enhancements as described herein. For example, the communications manager 1020 may include a scheduling request correspondence component 1025, a scheduling request component 1030, a UE operation component 1035, a report formatting component 1040, a report indexing component 1045, an SSSG component 1050, a communication state component 1055, a MAC-CE component 1060, an BSR component 1065, an LCG component 1070, a PUCCH resource component 1075, a UCI component 1080, a report request component 1085, a report indication component 1090, a L1 and L2 resource component 1095, a timing component 1001, a timing alteration component 1005, or any combination thereof. Each of these components may communicate, directly or indirectly, with one another (e.g., via one or more buses).

The communications manager 1020 may support wireless communication at a UE in accordance with examples as disclosed herein. The scheduling request correspondence component 1025 is capable of, configured to, or operable to support a means for receiving first control information indicative of a correspondence between one or more operations at the UE and at least one or more candidate values of a scheduling request. The scheduling request component 1030 is capable of, configured to, or operable to support a means for transmitting the scheduling request in accordance with the first control information, a value of the scheduling request indicative, at least in part, of a UE operation of the one or more operations. The UE operation component 1035 is capable of, configured to, or operable to support a means for performing the UE operation in accordance with the value of the scheduling request.

In some examples, the UE operation component 1035 is capable of, configured to, or operable to support a means for transmitting one of a BSR, a DSR, an ESR, or combinations thereof in accordance with the value of the scheduling request and the correspondence.

In some examples, the report formatting component 1040 is capable of, configured to, or operable to support a means for receiving, as part of the first control information, an indication of different reports or different report formats as the one or more operations at the UE, the one or more candidate values of the scheduling request each associated with a respective report or report format in accordance with the correspondence.

In some examples, the different report formats to include one or more of a first BSR which includes a first table, a second BSR which includes a second table different from the first table, or a third BSR which includes a two-part table.

In some examples, the report indexing component 1045 is capable of, configured to, or operable to support a means for receiving, as part of the first control information, an indication of different start indices of a report of the UE as the one or more operations at the UE, the one or more candidate values of the scheduling request each associated with a respective start index in accordance with the correspondence.

In some examples, the UE operation component 1035 is capable of, configured to, or operable to support a means for transmitting a MAC-CE indicative of an ESR in accordance with the value of the scheduling request and the correspondence, the MAC-CE also indicative of a BSR or report separate from the BSR.

In some examples, the UE operation component 1035 is capable of, configured to, or operable to support a means for cancelling a PDCCH skip procedure in accordance with the value of the scheduling request and the correspondence.

In some examples, the SSSG component 1050 is capable of, configured to, or operable to support a means for switching between operations in a first SSSG to operations in a second SSSG in accordance with the value of the scheduling request and the correspondence.

In some examples, the communication state component 1055 is capable of, configured to, or operable to support a means for switching between a first communications state to a second communications state in accordance with the value of the scheduling request and the correspondence.

In some examples, the MAC-CE component 1060 is capable of, configured to, or operable to support a means for transmitting, via layer 1 resources or layer 2 resources, a MAC-CE that requests to operate in a first SSSG, to skip one or more PDCCH resources, or to operate in a first communications state, the request of the MAC-CE being in accordance with the value of the scheduling request and the correspondence.

In some examples, the L1 and L2 resource component 1095 is capable of, configured to, or operable to support a means for receiving control signaling indicating the layer 1 resources or the layer 2 resources for transmission of the MAC-CE.

In some examples, the BSR component 1065 is capable of, configured to, or operable to support a means for transmitting a BSR that includes a second value, the correspondence to be further between the UE operation and a combination of the value of the scheduling request and the second value of the BSR and performance of the UE operation to be further in accordance with the combination of the value of the scheduling request and the second value of the BSR.

In some examples, the UE operation component 1035 is capable of, configured to, or operable to support a means for transmitting one of a DSR, an ESR, an indication of a SSSG switch, or of a PDCCH skip procedure update, in combination with the BSR in accordance with the value of the scheduling request, the second value of the BSR, and the correspondence.

In some examples, the DSR may be indicative of one of a set of multiple values associated with the DSR based on the combination of the value of the scheduling request, the second value of the BSR, and the correspondence.

In some examples, the DSR may be indicative that a remaining packet delay budget, a wait time of an uplink message of the UE, or both satisfy one or more delay thresholds based on the combination of the value of the scheduling request, the second value of the BSR, and the correspondence.

In some examples, the ESR may be indicative of one of a set of multiple values associated with the ESR based on the combination of the value of the scheduling request, the second value of the BSR, and the correspondence.

In some examples, the ESR may be indicative of one of a charging rate of the UE, a charging request of the UE, or a combination thereof based on the combination of the value of the scheduling request, the second value of the BSR, and the correspondence.

In some examples, the LCG component 1070 is capable of, configured to, or operable to support a means for receiving, as part of the first control information, an indication that the scheduling request is associated with a reduced quantity of LCGs, the value of the scheduling request indicative that a BSR is to include information associated with the reduced quantity of LCGs. In some examples, the BSR component 1065 is capable of, configured to, or operable to support a means for transmitting the BSR that includes the information associated with the reduced quantity of LCGs in accordance with the value of the scheduling request and the correspondence, a header of the BSR indicative of one or more unused portions of the BSR.

In some examples, the one or more unused portions of the BSR may include the information associated with the reduced quantity of LCGs, the information to include an ESR associated with each of the reduced quantity of LCGs, a DSR associated with each of the reduced quantity of LCGs, the BSR associated with each of the reduced quantity of LCGs, or a combination thereof.

In some examples, each LCG of the reduced quantity of LCGs may be associated with a respective priority.

In some examples, the information associated with the reduced quantity of LCGs may be jointly encoded in the one or more unused portions of the BSR.

In some examples, a first unused portion of the one or more unused portions of the BSR may include a codeword indicative of at least a type of the information included in the one or more unused portions of the BSR, a format of the information included in the one or more unused portions of the BSR, a table associated with the information included in the one or more unused portions of the BSR, or a combination thereof.

In some examples, the value of the scheduling request may include at least two bits of information.

In some examples, the PUCCH resource component 1075 is capable of, configured to, or operable to support a means for receiving second control information that indicates a set of PUCCH resources. In some examples, the UCI component 1080 is capable of, configured to, or operable to support a means for transmitting, via a resource of the set of PUCCH resources, UCI indicative of a type of a report to be transmitted via a MAC-CE. In some examples, the MAC-CE component 1060 is capable of, configured to, or operable to support a means for transmitting the MAC-CE that includes the report in accordance with the UCI.

In some examples, the report request component 1085 is capable of, configured to, or operable to support a means for receiving a request for the UE to report at least one of a set of multiple reports. In some examples, the report indication component 1090 is capable of, configured to, or operable to support a means for transmitting an indication that the UE is to transmit a first report of the set of multiple reports and a first format of the first report, the first format of the first report to be based on a quantity of bits associated with a set of multiple LCGs at the UE. In some examples, the report formatting component 1040 is capable of, configured to, or operable to support a means for transmitting the first report formatted in accordance with the indication.

In some examples, performance of the UE operation may be in accordance with a duration of a timer.

In some examples, the timing component 1001 is capable of, configured to, or operable to support a means for transmitting a message that includes a request to alter the duration of the timer. In some examples, the timing alteration component 1005 is capable of, configured to, or operable to support a means for receiving a second message to alter the duration of the timer based on the request, performance the UE operation to be based on the second message to alter the duration of the timer.

In some examples, the UE operation may be at least a transmission of one of a BSR, a DSR, or an ESR, and the value of the scheduling request to be based on a respective priority associated with each of the BSR, the DSR, and the ESR.

In some examples, one of the one or more candidate values of the scheduling request included in the correspondence may be zero.

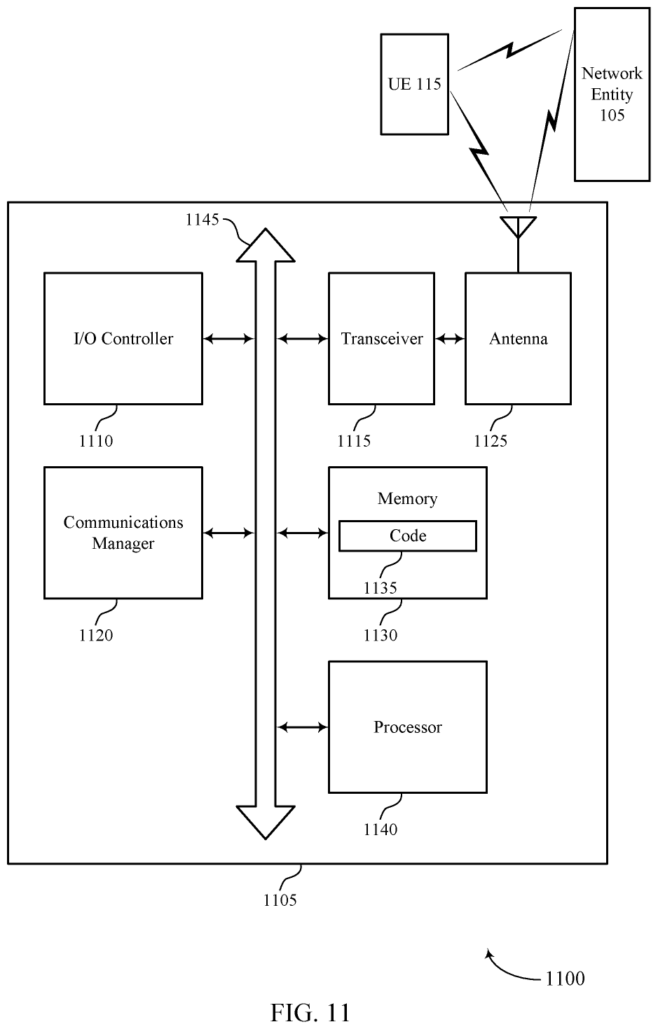

FIG. 11 shows a diagram of a system 1100 including a device 1105 that supports scheduling request-indicated reporting enhancements in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting scheduling request-indicated reporting enhancements). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 is capable of, configured to, or operable to support a means for receiving first control information indicative of a correspondence between one or more operations at the UE and at least one or more candidate values of a scheduling request. The communications manager 1120 is capable of, configured to, or operable to support a means for transmitting the scheduling request in accordance with the first control information, a value of the scheduling request indicative, at least in part, of a UE operation of the one or more operations. The communications manager 1120 is capable of, configured to, or operable to support a means for performing the UE operation in accordance with the value of the scheduling request.

By including or configuring the communications manager 1120 in accordance with examples as described herein, the device 1105 may support techniques for indicating one or more UE operations via a value (e.g., zero) of a scheduling request, thereby resulting in more efficient utilization of communication resources, improved coordination between devices, and reduced overhead at the device.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of scheduling request-indicated reporting enhancements as described herein, or the processor 1140 and the memory 1130 may be otherwise configured to perform or support such operations.

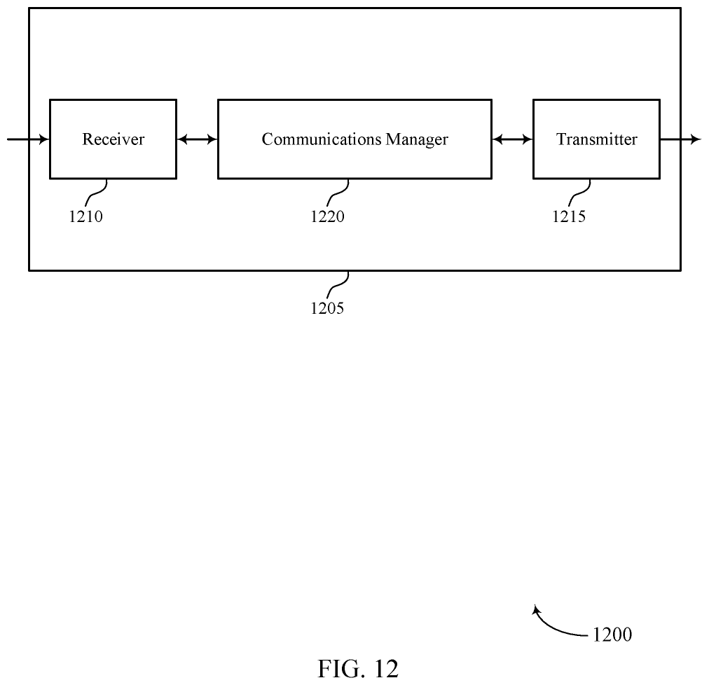

FIG. 12 shows a block diagram 1200 of a device 1205 that supports scheduling request-indicated reporting enhancements in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of scheduling request-indicated reporting enhancements as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 is capable of, configured to, or operable to support a means for outputting first control information indicative of a correspondence between one or more operations at a UE and at least one or more candidate values of a scheduling request. The communications manager 1220 is capable of, configured to, or operable to support a means for obtaining the scheduling request in accordance with the first control information, a value of the scheduling request indicative, at least in part, of a UE operation of the one or more operations. The communications manager 1220 is capable of, configured to, or operable to support a means for performing a network operation corresponding to the UE operation that is in accordance with the value of the scheduling request.

The communications manager 1220 may be an example of means for performing various aspects of scheduling request-indicated reporting enhancements as described herein. The communications manager 820, or its sub-components, may be implemented in hardware (e.g., in communications management circuitry). The circuitry may comprise of processor, DSP, an ASIC, a FPGA, or other programmable logic device, discrete gate or transistor logic, discrete hardware components, or any combination thereof designed to perform the functions described in the present disclosure.

In another implementation, the communications manager 1220, or its sub-components, may be implemented in code (e.g., as communications management software or firmware) executed by a processor, or any combination thereof. If implemented in code executed by a processor, the functions of the communications manager 1220, or its sub-components may be executed by a general-purpose processor, a DSP, an ASIC, a FPGA, or other programmable logic device.

In some examples, the communication manager 1220 may be configured to perform various operations (e.g., receiving and transmitting) using or otherwise in cooperation with the receiver 1210, the transmitter 1215, or both.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for indicating one or more UE operations via a value (e.g., zero) of a scheduling request, thereby resulting in more efficient utilization of communication resources.

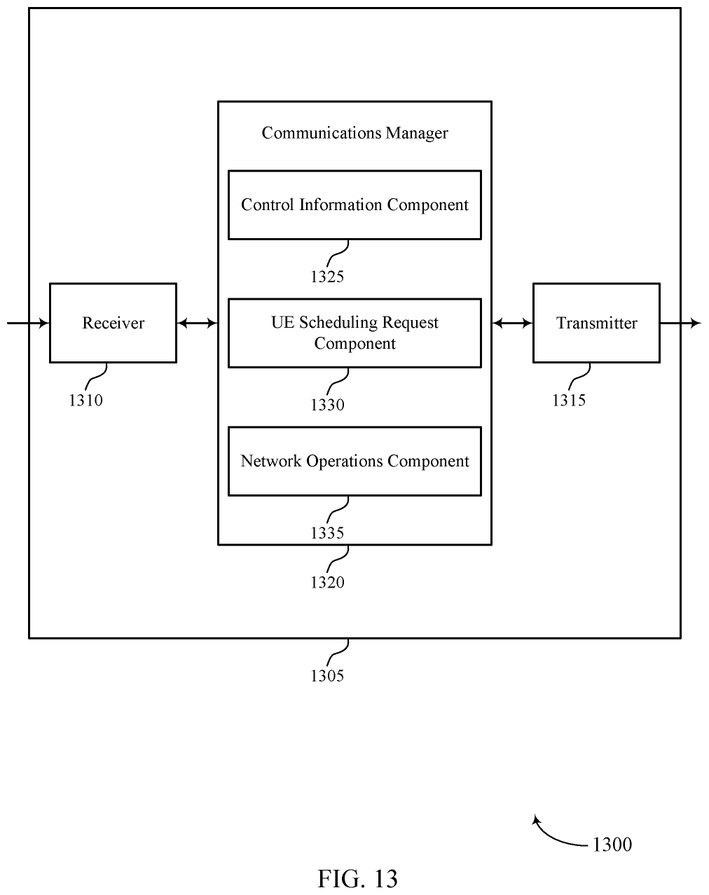

FIG. 13 shows a block diagram 1300 of a device 1305 that supports scheduling request-indicated reporting enhancements in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of scheduling request-indicated reporting enhancements as described herein. For example, the communications manager 1320 may include a control information component 1325, a UE scheduling request component 1330, a network operations component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The control information component 1325 is capable of, configured to, or operable to support a means for outputting first control information indicative of a correspondence between one or more operations at a UE and at least one or more candidate values of a scheduling request. The UE scheduling request component 1330 is capable of, configured to, or operable to support a means for obtaining the scheduling request in accordance with the first control information, a value of the scheduling request indicative, at least in part, of a UE operation of the one or more operations. The network operations component 1335 is capable of, configured to, or operable to support a means for performing a network operation corresponding to the UE operation that is in accordance with the value of the scheduling request.

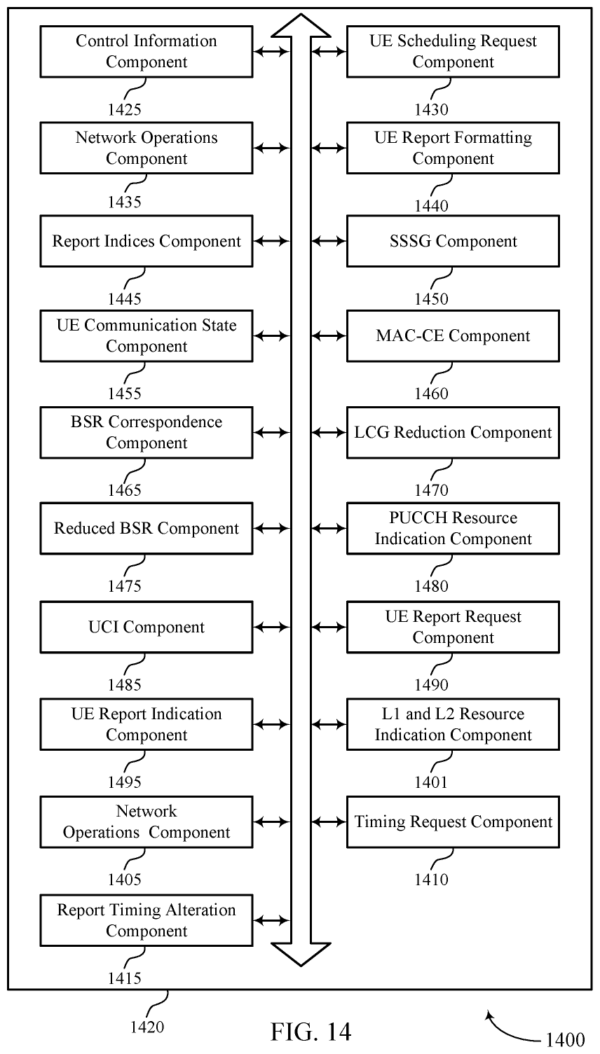

FIG. 14 shows a block diagram 1400 of a communications manager 1420 that supports scheduling request-indicated reporting enhancements in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of scheduling request-indicated reporting enhancements as described herein. For example, the communications manager 1420 may include a control information component 1425, a UE scheduling request component 1430, a network operations component 1435, a UE report formatting component 1440, a report indices component 1445, an SSSG component 1450, a UE communication state component 1455, a MAC-CE component 1460, an BSR correspondence component 1465, an LCG reduction component 1470, a reduced BSR component 1475, a PUCCH resource indication component 1480, a UCI component 1485, a UE report request component 1490, a UE report indication component 1495, a L1 and L2 resource indication component 1401, a network operations component 1405, a timing request component 1410, a report timing alteration component 1415, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The control information component 1425 is capable of, configured to, or operable to support a means for outputting first control information indicative of a correspondence between one or more operations at a UE and at least one or more candidate values of a scheduling request. The UE scheduling request component 1430 is capable of, configured to, or operable to support a means for obtaining the scheduling request in accordance with the first control information, a value of the scheduling request indicative, at least in part, of a UE operation of the one or more operations. The network operations component 1435 is capable of, configured to, or operable to support a means for performing a network operation corresponding to the UE operation that is in accordance with the value of the scheduling request.

In some examples, the network operations component 1435 is capable of, configured to, or operable to support a means for obtaining one of a BSR, a DSR, an ESR, or combinations thereof in accordance with the value of the scheduling request and the correspondence.

In some examples, the UE report formatting component 1440 is capable of, configured to, or operable to support a means for outputting, as part of the first control information, an indication of different reports or different report formats as the one or more operations at the UE, the one or more candidate values of the scheduling request each associated with a respective report or report format in accordance with the correspondence.

In some examples, the different report formats may include one or more of a first BSR which includes a first table, a second BSR which includes a second table different from the first table, or a third BSR which includes a two-part table.

In some examples, the report indices component 1445 is capable of, configured to, or operable to support a means for outputting, as part of the first control information, an indication of different start indices of a report of the UE as the one or more operations at the UE, the one or more candidate values of the scheduling request each associated with a respective start index in accordance with the correspondence.

In some examples, the network operations component 1435 is capable of, configured to, or operable to support a means for obtaining a MAC-CE indicative of an ESR in accordance with the value of the scheduling request and the correspondence, the MAC-CE also indicative of a BSR or report separate from the BSR.

In some examples, the network operations component 1435 is capable of, configured to, or operable to support a means for cancelling a PDCCH skip procedure in accordance with the value of the scheduling request and the correspondence.

In some examples, the SSSG component 1450 is capable of, configured to, or operable to support a means for switching between operations in a first SSSG to operations in a second SSSG in accordance with the value of the scheduling request and the correspondence.

In some examples, the UE communication state component 1455 is capable of, configured to, or operable to support a means for switching between a first communications state to a second communications state in accordance with the value of the scheduling request and the correspondence.

In some examples, the MAC-CE component 1460 is capable of, configured to, or operable to support a means for obtaining, via layer 1 resources or layer 2 resources, a MAC-CE that requests to operate in a first SSSG, to skip one or more PDCCH resources, or to operate in a first communications state, the request of the MAC-CE being in accordance with the value of the scheduling request and the correspondence.

In some examples, the L1 and L2 resource indication component 1401 is capable of, configured to, or operable to support a means for outputting control signaling indicating the layer 1 resources or the layer 2 resources for transmission of the MAC-CE.

In some examples, the BSR correspondence component 1465 is capable of, configured to, or operable to support a means for obtaining a BSR that includes a second value, the correspondence to be further between the UE operation and a combination of the value of the scheduling request and the second value of the BSR and performance of the network operation that corresponds to the UE operation to be further in accordance with the combination of the value of the scheduling request and the second value of the BSR.

In some examples, the network operations component 1405 is capable of, configured to, or operable to support a means for obtaining one of a DSR, an ESR, an indication of a SSSG switch, or of a PDCCH skip procedure update, in combination with the BSR in accordance with the value of the scheduling request, the second value of the BSR, and the correspondence.

In some examples, the DSR indicative of one of a set of multiple values associated with the DSR based on the combination of the value of the scheduling request, the second value of the BSR, and the correspondence.

In some examples, the DSR indicative that a remaining packet delay budget, a wait time of an uplink message of the UE, or both satisfy one or more delay thresholds based on the combination of the value of the scheduling request, the second value of the BSR, and the correspondence.

In some examples, the ESR indicative of one of a set of multiple values associated with the ESR based on the combination of the value of the scheduling request, the second value of the BSR, and the correspondence.

In some examples, the ESR indicative of one of a charging rate of the UE, a charging request of the UE, or a combination thereof based on the combination of the value of the scheduling request, the second value of the BSR, and the correspondence.

In some examples, the LCG reduction component 1470 is capable of, configured to, or operable to support a means for outputting, as part of the first control information, an indication that the scheduling request is associated with a reduced quantity of LCGs, the value of the scheduling request indicative that a BSR is to include information associated with the reduced quantity of LCGs. In some examples, the reduced BSR component 1475 is capable of, configured to, or operable to support a means for obtaining the BSR that includes the information associated with the reduced quantity of LCGs in accordance with the value of the scheduling request and the correspondence, a header of the BSR indicative of one or more unused portions of the BSR.

In some examples, the one or more unused portions of the BSR to include the information associated with the reduced quantity of LCGs, the information to include an ESR associated with each of the reduced quantity of LCGs, a DSR associated with each of the reduced quantity of LCGs, the BSR associated with each of the reduced quantity of LCGs, or a combination thereof.

In some examples, each LCG of the reduced quantity of LCGs to be associated with a respective priority.

In some examples, the information associated with the reduced quantity of LCGs to be jointly encoded in the one or more unused portions of the BSR.

In some examples, a first unused portion of the one or more unused portions of the BSR to include a codeword indicative of at least a type of the information included in the one or more unused portions of the BSR, a format of the information included in the one or more unused portions of the BSR, a table associated with the information included in the one or more unused portions of the BSR, or a combination thereof.

In some examples, the scheduling request to include at least two bits of information.

In some examples, the PUCCH resource indication component 1480 is capable of, configured to, or operable to support a means for outputting second control information that indicates a set of PUCCH resources. In some examples, the UCI component 1485 is capable of, configured to, or operable to support a means for obtaining, via a resource of the set of PUCCH resources, UCI indicative of a type of a report to be transmitted via a MAC-CE. In some examples, the MAC-CE component 1460 is capable of, configured to, or operable to support a means for obtaining the MAC-CE that includes the report in accordance with the UCI.

In some examples, the UE report request component 1490 is capable of, configured to, or operable to support a means for outputting a request for the UE to report at least one of a set of multiple reports. In some examples, the UE report indication component 1495 is capable of, configured to, or operable to support a means for obtaining an indication that the UE is to transmit a first report of the set of multiple reports and a first format of the first report, the first format of the first report to be based on a quantity of bits associated with a set of multiple LCGs at the UE. In some examples, the UE report formatting component 1440 is capable of, configured to, or operable to support a means for obtaining the first report formatted in accordance with the indication.

In some examples, performance of the network operation to be in accordance with a duration of a timer.

In some examples, the timing request component 1410 is capable of, configured to, or operable to support a means for obtaining a message that includes a request to alter the duration of the timer. In some examples, the report timing alteration component 1415 is capable of, configured to, or operable to support a means for outputting a second message to alter the duration of the timer based on the request, performance of the network operation to be based on the second message to alter the duration of the timer.

In some examples, the network operation to be at least a reception of one of a BSR, a DSR, or an ESR, and the value of the scheduling request to be based on a respective priority associated with each of the BSR, the DSR, and the ESR.

In some examples, one of the one or more candidate values of the scheduling request included in the correspondence being zero.

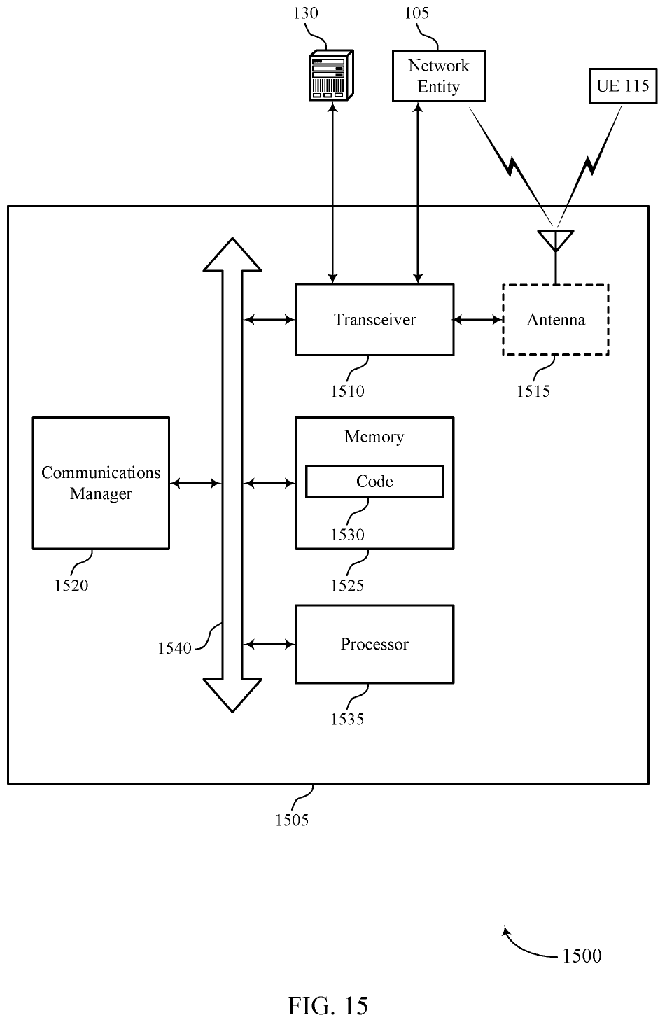

FIG. 15 shows a diagram of a system 1500 including a device 1505 that supports scheduling request-indicated reporting enhancements in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting scheduling request-indicated reporting enhancements). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 is capable of, configured to, or operable to support a means for outputting first control information indicative of a correspondence between one or more operations at a UE and at least one or more candidate values of a scheduling request. The communications manager 1520 is capable of, configured to, or operable to support a means for obtaining the scheduling request in accordance with the first control information, a value of the scheduling request indicative, at least in part, of a UE operation of the one or more operations. The communications manager 1520 is capable of, configured to, or operable to support a means for performing a network operation corresponding to the UE operation that is in accordance with the value of the scheduling request.

By including or configuring the communications manager 1520 in accordance with examples as described herein, the device 1505 may support techniques for indicating one or more UE operations via a value (e.g., zero) of a scheduling request, thereby resulting in more efficient utilization of communication resources.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of scheduling request-indicated reporting enhancements as described herein, or the processor 1535 and the memory 1525 may be otherwise configured to perform or support such operations.

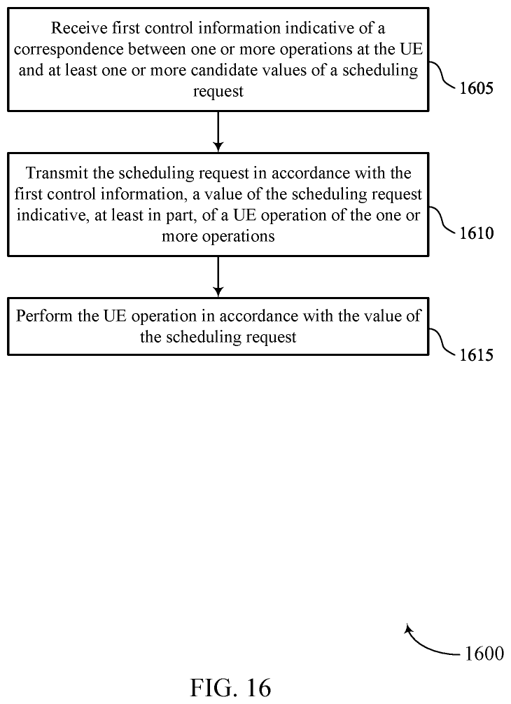

FIG. 16 shows a flowchart illustrating a method 1600 that supports scheduling request-indicated reporting enhancements in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1605, the method may include receiving first control information indicative of a correspondence between one or more operations at the UE and at least one or more candidate values of a scheduling request. The operations of 1605 may be performed in accordance with examples as disclosed herein. In some examples, aspects of the operations of 1605 may be performed by a scheduling request correspondence component 1025 as described with reference to FIG. 10.

At 1610, the method may include transmitting the scheduling request in accordance with the first control information, a value of the scheduling request indicative, at least in part, of a UE operation of the one or more operations. The operations of 1610 may be performed in accordance with examples as disclosed herein. In some examples, aspects of the operations of 1610 may be performed by a scheduling request component 1030 as described with reference to FIG. 10.

At 1615, the method may include performing the UE operation in accordance with the value of the scheduling request. The operations of 1615 may be performed in accordance with examples as disclosed herein. In some examples, aspects of the operations of 1615 may be performed by a UE operation component 1035 as described with reference to FIG. 10.

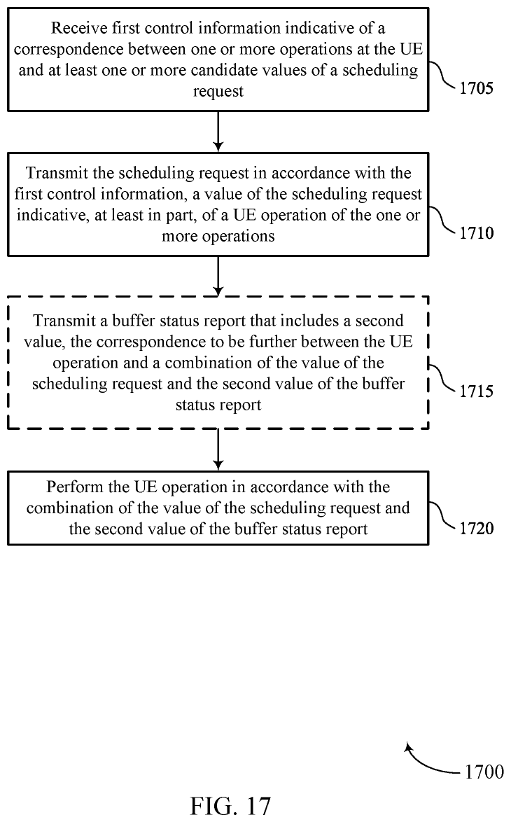

FIG. 17 shows a flowchart illustrating a method 1700 that supports scheduling request-indicated reporting enhancements in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1705, the method may include receiving first control information indicative of a correspondence between one or more operations at the UE and at least one or more candidate values of a scheduling request. The operations of 1705 may be performed in accordance with examples as disclosed herein. In some examples, aspects of the operations of 1705 may be performed by a scheduling request correspondence component 1025 as described with reference to FIG. 10.

At 1710, the method may include transmitting the scheduling request in accordance with the first control information, a value of the scheduling request indicative, at least in part, of a UE operation of the one or more operations. The operations of 1710 may be performed in accordance with examples as disclosed herein. In some examples, aspects of the operations of 1710 may be performed by a scheduling request component 1030 as described with reference to FIG. 10.

At 1715, the method may include transmitting a BSR that includes a second value, the correspondence to be further between the UE operation and a combination of the value of the scheduling request and the second value of the BSR. The operations of 1715 may be performed in accordance with examples as disclosed herein. In some examples, aspects of the operations of 1715 may be performed by an BSR component 1065 as described with reference to FIG. 10.

At 1720, the method may include performing the UE operation in accordance with the combination of the value of the scheduling request and the second value of the BSR. The operations of 1720 may be performed in accordance with examples as disclosed herein. In some examples, aspects of the operations of 1720 may be performed by a UE operation component 1035 as described with reference to FIG. 10.

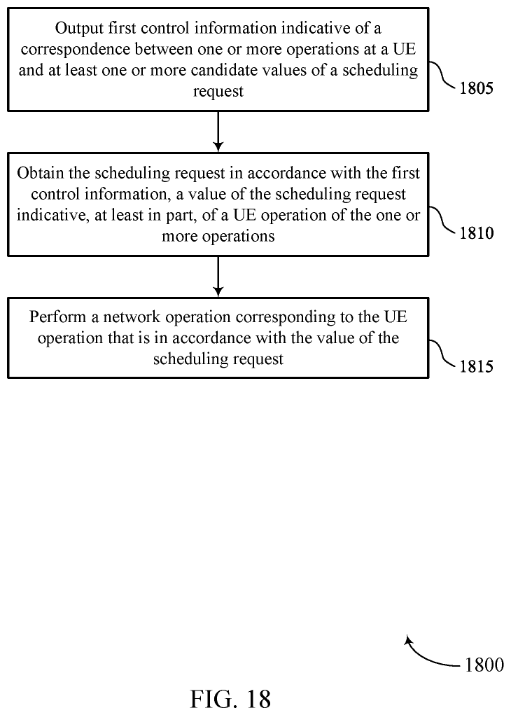

FIG. 18 shows a flowchart illustrating a method 1800 that supports scheduling request-indicated reporting enhancements in accordance with aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 1805, the method may include outputting first control information indicative of a correspondence between one or more operations at a UE and at least one or more candidate values of a scheduling request. The operations of 1805 may be performed in accordance with examples as disclosed herein. In some examples, aspects of the operations of 1805 may be performed by a control information component 1425 as described with reference to FIG. 14.

At 1810, the method may include obtaining the scheduling request in accordance with the first control information, a value of the scheduling request indicative, at least in part, of a UE operation of the one or more operations. The operations of 1810 may be performed in accordance with examples as disclosed herein. In some examples, aspects of the operations of 1810 may be performed by a UE scheduling request component 1430 as described with reference to FIG. 14.

At 1815, the method may include performing a network operation corresponding to the UE operation that is in accordance with the value of the scheduling request. The operations of 1815 may be performed in accordance with examples as disclosed herein. In some examples, aspects of the operations of 1815 may be performed by a network operations component 1435 as described with reference to FIG. 14.

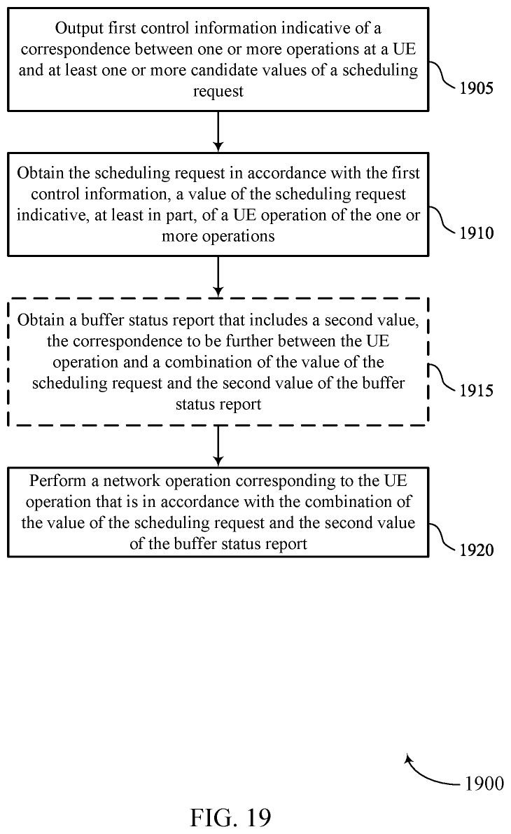

FIG. 19 shows a flowchart illustrating a method 1900 that supports scheduling request-indicated reporting enhancements in accordance with aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 1905, the method may include outputting first control information indicative of a correspondence between one or more operations at a UE and at least one or more candidate values of a scheduling request. The operations of 1905 may be performed in accordance with examples as disclosed herein. In some examples, aspects of the operations of 1905 may be performed by a control information component 1425 as described with reference to FIG. 14.

At 1910, the method may include obtaining the scheduling request in accordance with the first control information, a value of the scheduling request indicative, at least in part, of a UE operation of the one or more operations. The operations of 1910 may be performed in accordance with examples as disclosed herein. In some examples, aspects of the operations of 1910 may be performed by a UE scheduling request component 1430 as described with reference to FIG. 14.

At 1915, the method may include obtaining a BSR that includes a second value, the correspondence to be further between the UE operation and a combination of the value of the scheduling request and the second value of the BSR. The operations of 1915 may be performed in accordance with examples as disclosed herein. In some examples, aspects of the operations of 1915 may be performed by an BSR correspondence component 1465 as described with reference to FIG. 14.

At 1920, the method may include performing a network operation corresponding to the UE operation that is in accordance with the combination of the value of the scheduling request and the second value of the BSR. The operations of 1920 may be performed in accordance with examples as disclosed herein. In some examples, aspects of the operations of 1920 may be performed by a network operations component 1435 as described with reference to FIG. 14.

The following provides an overview of aspects of the present disclosure:

Aspect 1: A method for wireless communication at a UE, comprising: receiving first control information indicative of a correspondence between one or more operations at the UE and at least one or more candidate values of a scheduling request; transmitting the scheduling request in accordance with the first control information, a value of the scheduling request indicative, at least in part, of a UE operation of the one or more operations; and performing the UE operation in accordance with the value of the scheduling request.

Aspect 2: The method of aspect 1, performing the UE operation further comprising: transmitting one of a BSR, a DSR, an DSR, or combinations thereof in accordance with the value of the scheduling request and the correspondence.

Aspect 3: The method of any of aspects 1 through 2, further comprising: receiving, as part of the first control information, an indication of different reports or different report formats as the one or more operations at the UE, the one or more candidate values of the scheduling request each associated with a respective report or report format in accordance with the correspondence.

Aspect 4: The method of aspect 3, wherein the different report formats to include one or more of a first BSR which includes a first table, a second BSR which includes a second table different from the first table, or a third BSR which includes a two-part table.

Aspect 5: The method of any of aspects 1 through 4, further comprising: receiving, as part of the first control information, an indication of different start indices of a report of the UE as the one or more operations at the UE, the one or more candidate values of the scheduling request each associated with a respective start index in accordance with the correspondence.

Aspect 6: The method of any of aspects 1 through 5, performing the UE operation further comprising: transmitting a MAC-CE indicative of an DSR in accordance with the value of the scheduling request and the correspondence, the MAC-CE also indicative of a BSR or report separate from the BSR.

Aspect 7: The method of any of aspects 1 through 6, performing the UE operation further comprising: cancelling a PDCCH skip procedure in accordance with the value of the scheduling request and the correspondence.

Aspect 8: The method of any of aspects 1 through 7, further comprising: switching between operations in a first SSSG to operations in a second SSSG in accordance with the value of the scheduling request and the correspondence.

Aspect 9: The method of any of aspects 1 through 8, further comprising: switching between a first communications state to a second communications state in accordance with the value of the scheduling request and the correspondence.

Aspect 10: The method of any of aspects 1 through 9, further comprising: transmitting, via L1 resources or L2 resources, a MAC-CE that requests to operate in a first SSSG, to skip one or more PDCCH resources, or to operate in a first communications state, the request of the MAC-CE being in accordance with the value of the scheduling request and the correspondence.

Aspect 11: The method of aspect 10, further comprising: receiving control signaling indicating the L1 resources or the L2 resources for transmission of the MAC-CE.

Aspect 12: The method of any of aspects 1 through 11, further comprising: transmitting a BSR that includes a second value, the correspondence to be further between the UE operation and a combination of the value of the scheduling request and the second value of the BSR and performance of the UE operation to be further in accordance with the combination of the value of the scheduling request and the second value of the BSR.

Aspect 13: The method of aspect 12, further comprising: transmitting one of a DSR, an DSR, an indication of a SSSG switch, or of a PDCCH skip procedure update, in combination with the BSR in accordance with the value of the scheduling request, the second value of the BSR, and the correspondence.

Aspect 14: The method of aspect 13, wherein the DSR indicative of one of a plurality of values associated with the DSR based at least in part on the combination of the value of the scheduling request, the second value of the BSR, and the correspondence.

Aspect 15: The method of any of aspects 13 through 14, wherein the DSR indicative that a remaining PDB, a wait time of an uplink message of the UE, or both satisfy one or more delay thresholds based at least in part on the combination of the value of the scheduling request, the second value of the BSR, and the correspondence.

Aspect 16: The method of any of aspects 13 through 15, wherein the DSR indicative of one of a plurality of values associated with the DSR based at least in part on the combination of the value of the scheduling request, the second value of the BSR, and the correspondence.

Aspect 17: The method of any of aspects 13 through 16, wherein the DSR indicative of one of a charging rate of the UE, a charging request of the UE, or a combination thereof based at least in part on the combination of the value of the scheduling request, the second value of the BSR, and the correspondence.

Aspect 18: The method of any of aspects 1 through 17, further comprising: receiving, as part of the first control information, an indication that the scheduling request is associated with a reduced quantity of LCGs, the value of the scheduling request indicative that a BSR is to include information associated with the reduced quantity of LCGs; and transmitting the BSR that includes the information associated with the reduced quantity of LCGs in accordance with the value of the scheduling request and the correspondence, a header of the BSR indicative of one or more unused portions of the BSR.

Aspect 19: The method of aspect 18, wherein the one or more unused portions of the BSR to include the information associated with the reduced quantity of LCGs, the information to include an DSR associated with each of the reduced quantity of LCGs, a DSR associated with each of the reduced quantity of LCGs, the BSR associated with each of the reduced quantity of LCGs, or a combination thereof.

Aspect 20: The method of any of aspects 18 through 19, wherein each LCG of the reduced quantity of LCGs to be associated with a respective priority.

Aspect 21: The method of any of aspects 18 through 20, wherein the information associated with the reduced quantity of LCGs to be jointly encoded in the one or more unused portions of the BSR.

Aspect 22: The method of any of aspects 18 through 21, wherein a first unused portion of the one or more unused portions of the BSR to include a codeword indicative of at least a type of the information included in the one or more unused portions of the BSR, a format of the information included in the one or more unused portions of the BSR, a table associated with the information included in the one or more unused portions of the BSR, or a combination thereof.

Aspect 23: The method of any of aspects 1 through 22, wherein the value of the scheduling request to comprise at least two bits of information.

Aspect 24: The method of any of aspects 1 through 23, further comprising: receiving second control information that indicates a set of PUCCH resources; transmitting, via a resource of the set of PUCCH resources, uplink control information indicative of a type of a report to be transmitted via a MAC-CE; and transmitting the MAC-CE that includes the report in accordance with the uplink control information.

Aspect 25: The method of any of aspects 1 through 24, further comprising: receiving a request for the UE to report at least one of a plurality of reports; transmitting an indication that the UE is to transmit a first report of the plurality of reports and a first format of the first report, the first format of the first report to be based at least in part on a quantity of bits associated with a plurality of LCGs at the UE; and transmitting the first report formatted in accordance with the indication.

Aspect 26: The method of any of aspects 1 through 25, wherein performance of the UE operation to be in accordance with a duration of a timer.

Aspect 27: The method of aspect 26, further comprising: transmitting a message that includes a request to alter the duration of the timer; and receiving a second message to alter the duration of the timer based at least in part on the request, performance the UE operation to be based at least in part on the second message to alter the duration of the timer.

Aspect 28: The method of any of aspects 1 through 27, wherein the UE operation to be at least a transmission of one of a BSR, a DSR, or an DSR, and the value of the scheduling request to be based at least in part on a respective priority associated with each of the BSR, the DSR, and the DSR.

Aspect 29: The method of any of aspects 1 through 28, wherein one of the one or more candidate values of the scheduling request included in the correspondence being zero.

Aspect 30: A method for wireless communication at a network entity, comprising: outputting first control information indicative of a correspondence between one or more operations at a UE and at least one or more candidate values of a scheduling request; obtaining the scheduling request in accordance with the first control information, a value of the scheduling request indicative, at least in part, of a UE operation of the one or more operations; and performing a network operation corresponding to the UE operation that is in accordance with the value of the scheduling request.

Aspect 31: The method of aspect 30, performing the network operation further comprising: obtaining one of a BSR, a DSR, an DSR, or combinations thereof in accordance with the value of the scheduling request and the correspondence.

Aspect 32: The method of any of aspects 30 through 31, further comprising: outputting, as part of the first control information, an indication of different reports or different report formats as the one or more operations at the UE, the one or more candidate values of the scheduling request each associated with a respective report or report format in accordance with the correspondence.

Aspect 33: The method of aspect 32, wherein the different report formats to include one or more of a first BSR which includes a first table, a second BSR which includes a second table different from the first table, or a third BSR which includes a two-part table.

Aspect 34: The method of any of aspects 30 through 33, further comprising: outputting, as part of the first control information, an indication of different start indices of a report of the UE as the one or more operations at the UE, the one or more candidate values of the scheduling request each associated with a respective start index in accordance with the correspondence.

Aspect 35: The method of any of aspects 30 through 34, performing the network operation further comprising: obtaining a MAC-CE indicative of an DSR in accordance with the value of the scheduling request and the correspondence, the MAC-CE also indicative of a BSR or report separate from the BSR.

Aspect 36: The method of any of aspects 30 through 35, performing the network operation further comprising: cancelling a PDCCH skip procedure in accordance with the value of the scheduling request and the correspondence.

Aspect 37: The method of any of aspects 30 through 36, further comprising:

switching between operations in a first SSSG to operations in a second SSSG in accordance with the value of the scheduling request and the correspondence.

Aspect 38: The method of any of aspects 30 through 37, further comprising: switching between a first communications state to a second communications state in accordance with the value of the scheduling request and the correspondence.

Aspect 39: The method of any of aspects 30 through 38, further comprising: obtaining, via L1 resources or L2 resources, a MAC-CE that requests to operate in a first SSSG, to skip one or more PDCCH resources, or to operate in a first communications state, the request of the MAC-CE being in accordance with the value of the scheduling request and the correspondence.

Aspect 40: The method of aspect 39, further comprising: outputting control signaling indicating the L1 resources or the L2 resources for transmission of the MAC-CE.

Aspect 41: The method of any of aspects 30 through 40, further comprising: obtaining a BSR that includes a second value, the correspondence to be further between the UE operation and a combination of the value of the scheduling request and the second value of the BSR and performance of the network operation that corresponds to the UE operation to be further in accordance with the combination of the value of the scheduling request and the second value of the BSR.

Aspect 42: The method of aspect 41, further comprising: obtaining one of a DSR, an DSR, an indication of a SSSG switch, or of a PDCCH skip procedure update, in combination with the BSR in accordance with the value of the scheduling request, the second value of the BSR, and the correspondence.

Aspect 43: The method of aspect 42, wherein the DSR indicative of one of a plurality of values associated with the DSR based at least in part on the combination of the value of the scheduling request, the second value of the BSR, and the correspondence.

Aspect 44: The method of any of aspects 42 through 43, wherein the DSR indicative that a remaining PDB, a wait time of an uplink message of the UE, or both satisfy one or more delay thresholds based at least in part on the combination of the value of the scheduling request, the second value of the BSR, and the correspondence.

Aspect 45: The method of any of aspects 42 through 44, wherein the DSR indicative of one of a plurality of values associated with the DSR based at least in part on the combination of the value of the scheduling request, the second value of the BSR, and the correspondence.

Aspect 46: The method of any of aspects 42 through 45, wherein the DSR indicative of one of a charging rate of the UE, a charging request of the UE, or a combination thereof based at least in part on the combination of the value of the scheduling request, the second value of the BSR, and the correspondence.

Aspect 47: The method of any of aspects 30 through 46, further comprising: outputting, as part of the first control information, an indication that the scheduling request is associated with a reduced quantity of LCGs, the value of the scheduling request indicative that a BSR is to include information associated with the reduced quantity of LCGs; and obtaining the BSR that includes the information associated with the reduced quantity of LCGs in accordance with the value of the scheduling request and the correspondence, a header of the BSR indicative of one or more unused portions of the BSR.

Aspect 48: The method of aspect 47, wherein the one or more unused portions of the BSR to include the information associated with the reduced quantity of LCGs, the information to include an DSR associated with each of the reduced quantity of LCGs, a DSR associated with each of the reduced quantity of LCGs, the BSR associated with each of the reduced quantity of LCGs, or a combination thereof.

Aspect 49: The method of any of aspects 47 through 48, wherein each LCG of the reduced quantity of LCGs to be associated with a respective priority.

Aspect 50: The method of any of aspects 47 through 49, wherein the information associated with the reduced quantity of LCGs to be jointly encoded in the one or more unused portions of the BSR.

Aspect 51: The method of any of aspects 47 through 50, wherein a first unused portion of the one or more unused portions of the BSR to include a codeword indicative of at least a type of the information included in the one or more unused portions of the BSR, a format of the information included in the one or more unused portions of the BSR, a table associated with the information included in the one or more unused portions of the BSR, or a combination thereof.

Aspect 52: The method of any of aspects 30 through 51, wherein the scheduling request to comprise at least two bits of information.

Aspect 53: The method of any of aspects 30 through 52, further comprising: outputting second control information that indicates a set of PUCCH resources; obtaining, via a resource of the set of PUCCH resources, uplink control information indicative of a type of a report to be transmitted via a MAC-CE; and obtaining the MAC-CE that includes the report in accordance with the uplink control information.

Aspect 54: The method of any of aspects 30 through 53, further comprising: outputting a request for the UE to report at least one of a plurality of reports; obtaining an indication that the UE is to transmit a first report of the plurality of reports and a first format of the first report, the first format of the first report to be based at least in part on a quantity of bits associated with a plurality of LCGs at the UE; and obtaining the first report formatted in accordance with the indication.

Aspect 55: The method of any of aspects 30 through 54, wherein performance of the network operation to be in accordance with a duration of a timer.

Aspect 56: The method of aspect 55, further comprising: obtaining a message that includes a request to alter the duration of the timer; and outputting a second message to alter the duration of the timer based at least in part on the request, performance of the network operation to be based at least in part on the second message to alter the duration of the timer.

Aspect 57: The method of any of aspects 30 through 56, wherein the network operation to be at least a reception of one of a BSR, a DSR, or an DSR, and the value of the scheduling request to be based at least in part on a respective priority associated with each of the BSR, the DSR, and the DSR.

Aspect 58: The method of any of aspects 30 through 57, wherein one of the one or more candidate values of the scheduling request included in the correspondence being zero.

Aspect 59: An apparatus for wireless communication at a UE, comprising a processor; memory coupled with the processor; and instructions stored in the memory and executable by the processor to cause the apparatus to perform a method of any of aspects 1 through 29.

Aspect 60: An apparatus for wireless communication at a UE, comprising at least one means for performing a method of any of aspects 1 through 29.

Aspect 61: A non-transitory computer-readable medium storing code for wireless communication at a UE, the code comprising instructions executable by a processor to perform a method of any of aspects 1 through 29.

Aspect 62: An apparatus for wireless communication at a network entity, comprising a processor; memory coupled with the processor; and instructions stored in the memory and executable by the processor to cause the apparatus to perform a method of any of aspects 30 through 58.

Aspect 63: An apparatus for wireless communication at a network entity, comprising at least one means for performing a method of any of aspects 30 through 58.

Aspect 64: A non-transitory computer-readable medium storing code for wireless communication at a network entity, the code comprising instructions executable by a processor to perform a method of any of aspects 30 through 58.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled with the processor, the processor configured to:
receive first control information indicative of a correspondence between one or more operations at the UE and at least one or more candidate values of a scheduling request;
transmit the scheduling request in accordance with the first control information, a value of the scheduling request indicative, at least in part, of a UE operation of the one or more operations; and
perform the UE operation in accordance with the value of the scheduling request.

2. The apparatus of claim 1, wherein, to perform the UE operation, the processor is further configured to:
transmit one of a buffer status report, a delay status report, an energy status report, or combinations thereof in accordance with the value of the scheduling request and the correspondence.

3. The apparatus of claim 1, wherein the processor is further configured to:
receive, as part of the first control information, an indication of different reports or different report formats as the one or more operations at the UE, the one or more candidate values of the scheduling request each associated with a respective report or report format in accordance with the correspondence.

4. The apparatus of claim 3, wherein the different report formats include one or more of a first buffer status report which includes a first table, a second buffer status report which includes a second table different from the first table, or a third buffer status report which includes a two-part table.

5. The apparatus of claim 1, wherein the processor is further configured to:
receive, as part of the first control information, an indication of different start indices of a report of the UE as the one or more operations at the UE, the one or more candidate values of the scheduling request each associated with a respective start index in accordance with the correspondence.

6. The apparatus of claim 1, wherein, to perform the UE operation, the processor is further configured to:
transmit a medium access control-control element (MAC-CE) indicative of an energy status report in accordance with the value of the scheduling request and the correspondence, the MAC-CE also indicative of a buffer status report or report separate from the buffer status report.

7. The apparatus of claim 1, wherein, to perform the UE operation, the processor is further configured to:
cancel a physical downlink control channel skip procedure in accordance with the value of the scheduling request and the correspondence.

8. The apparatus of claim 1, wherein, to perform the UE operation, the processor is further configured to:
switch between operations in a first search space set group to operations in a second search space set group in accordance with the value of the scheduling request and the correspondence.

9. The apparatus of claim 1, wherein, to perform the UE operation, the processor is further configured to:
switch between a first communications state to a second communications state in accordance with the value of the scheduling request and the correspondence.

10. The apparatus of claim 1, wherein, to perform the UE operation, the processor is further configured to:
transmit, via layer 1 resources or layer 2 resources, a MAC-CE that requests to operate in a first search space set group, to skip one or more physical downlink control channel resources, or to operate in a first communications state, the request of the MAC-CE being in accordance with the value of the scheduling request and the correspondence.

11. The apparatus of claim 10, wherein the processor is further configured to:
receive control signaling that indicates the layer 1 resources or the layer 2 resources for transmission of the MAC-CE.

12. The apparatus of claim 1, wherein the processor is further configured to:
transmit a buffer status report that includes a second value, the correspondence to be further between the UE operation and a combination of the value of the scheduling request and the second value of the buffer status report and performance of the UE operation to be further in accordance with the combination of the value of the scheduling request and the second value of the buffer status report.

13. The apparatus of claim 12, wherein the processor is further configured to:
transmit one of a delay status report, an energy status report, an indication of a search space set group switch, or of a physical downlink control channel skip procedure update, in combination with the buffer status report in accordance with the value of the scheduling request, the second value of the buffer status report, and the correspondence.

14. The apparatus of claim 13, the delay status report indicative of one of a plurality of values associated with the delay status report based at least in part on the combination of the value of the scheduling request, the second value of the buffer status report, and the correspondence.

15. The apparatus of claim 13, the delay status report indicative that a remaining packet delay budget, a wait time of an uplink message of the UE, or both satisfy one or more delay thresholds based at least in part on the combination of the value of the scheduling request, the second value of the buffer status report, and the correspondence.

16. The apparatus of claim 13, the energy status report indicative of one of a plurality of values associated with the energy status report based at least in part on the combination of the value of the scheduling request, the second value of the buffer status report, and the correspondence.

17. The apparatus of claim 13, the energy status report indicative of one of a charging rate of the UE, a charging request of the UE, or a combination thereof based at least in part on the combination of the value of the scheduling request, the second value of the buffer status report, and the correspondence.

18. The apparatus of claim 1, wherein the processor is further configured to:
receive, as part of the first control information, an indication that the scheduling request is associated with a reduced quantity of logical channel groups, the value of the scheduling request indicative that a buffer status report is to include information associated with the reduced quantity of logical channel groups; and
transmit the buffer status report that includes the information associated with the reduced quantity of logical channel groups in accordance with the value of the scheduling request and the correspondence, a header of the buffer status report indicative of one or more unused portions of the buffer status report.

19. The apparatus of claim 18, the one or more unused portions of the buffer status report to include the information associated with the reduced quantity of logical channel groups, the information to include an energy status report associated with each of the reduced quantity of logical channel groups, a delay status report associated with each of the reduced quantity of logical channel groups, the buffer status report associated with each of the reduced quantity of logical channel groups, or a combination thereof.

20. The apparatus of claim 18, a first unused portion of the one or more unused portions of the buffer status report to include a codeword indicative of at least a type of the information included in the one or more unused portions of the buffer status report, a format of the information included in the one or more unused portions of the buffer status report, a table associated with the information included in the one or more unused portions of the buffer status report, or a combination thereof.

21. The apparatus of claim 1, the value of the scheduling request to comprise at least two bits of information.

22. The apparatus of claim 1, the UE operation to be at least a transmission of one of a buffer status report, a delay status report, or an energy status report, and the value of the scheduling request to be based at least in part on a respective priority associated with each of the buffer status report, the delay status report, and the energy status report.

23. The apparatus of claim 1, one of the one or more candidate values of the scheduling request included in the correspondence being zero.

24. An apparatus for wireless communication at a network entity, comprising:
a processor; and
memory coupled with the processor, the processor configured to:
output first control information indicative of a correspondence between one or more operations at a user equipment (UE) and at least one or more candidate values of a scheduling request;
obtain the scheduling request in accordance with the first control information, a value of the scheduling request indicative, at least in part, of a UE operation of the one or more operations; and
perform a network operation corresponding to the UE operation that is in accordance with the value of the scheduling request.

25. The apparatus of claim 24, wherein, to perform the network operation, the processor is further configured to:
obtain one of a buffer status report, a delay status report, an energy status report, or combinations thereof in accordance with the value of the scheduling request and the correspondence.

26. The apparatus of claim 24, wherein the processor is further configured to:
obtain a buffer status report that includes a second value, the correspondence to be further between the UE operation and a combination of the value of the scheduling request and the second value of the buffer status report and performance of the network operation that corresponds to the UE operation to be further in accordance with the combination of the value of the scheduling request and the second value of the buffer status report.

27. The apparatus of claim 24, the network operation to be at least a reception of one of a buffer status report, a delay status report, or an energy status report, and the value of the scheduling request to be based at least in part on a respective priority associated with each of the buffer status report, the delay status report, and the energy status report.

28. The apparatus of claim 24, one of the one or more candidate values of the scheduling request included in the correspondence being zero.

29. A method for wireless communication at a user equipment (UE), comprising:
receiving first control information indicative of a correspondence between one or more operations at the UE and at least one or more candidate values of a scheduling request;
transmitting the scheduling request in accordance with the first control information, a value of the scheduling request indicative, at least in part, of a UE operation of the one or more operations; and
performing the UE operation in accordance with the value of the scheduling request.

30. A method for wireless communication at a network entity, comprising:
outputting first control information indicative of a correspondence between one or more operations at a user equipment (UE) and at least one or more candidate values of a scheduling request;
obtaining the scheduling request in accordance with the first control information, a value of the scheduling request indicative, at least in part, of a UE operation of the one or more operations; and
performing a network operation corresponding to the UE operation that is in accordance with the value of the scheduling request.
